(19) United States
(12) Patent Application Publication
(10) Pub. No.: US 2026/0099050 A1
(43) Pub. Date: Apr. 9, 2026

(54) EXTENDING DISPLAY LIFETIME AND SAVING POWER IN OPEN-PERIPHERY HEAD MOUNTED DISPLAYS

(71) Applicant: Meta Platforms Technologies, LLC, Menlo Park, CA (US)

(72) Inventors: Ian ERKELENS, Kirkland, WA (US); Romain BACHY, Seattle, WA (US); Minjung KIM, Redmond, WA (US)

(21) Appl. No.: 18/910,366

(22) Filed: Oct. 9, 2024

(51) Int. Cl. G02B 27/01; G02B 27/00; G09G 3/18; G09G 3/19

(52) U.S. Cl. CPC G02B 27/0172; G02B 27/0093; G09G 3/18; G09G 3/19; G02B 2027/0118; G02B 2027/0178; G09G 2360/144

(57) ABSTRACT

A head-mounted display system includes a near-eye display configured to present images to a user's eye, one or more side shields that are configured to fill gaps between the user's face and peripheries of the near-eye display and are dimmable using an electrical control signal, and a controller configured to control dimming of the near-eye display and/or the one or more side shields based at least in part on the luminance and/or spectrum of ambient light, without causing a noticeable change of perceived brightness and/or color temperature by the user's eye.

### BACKGROUND

An artificial reality system, such as a head-mounted display (HMD) or heads-up display (HUD) system, generally includes a near-eye display system in the form of a headset or a pair of glasses and configured to present content to a user via an electronic or optic display that is within, for example, about 10-20 mm in front of the user's eyes. The head-mounted display system may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)), and the surrounding environment by, for example, seeing through transparent display glasses or lenses (often referred to as optical see-through) or viewing displayed images of the surrounding environment captured by a camera (often referred to as video see-through).

### SUMMARY

This disclosure relates generally to head-mounted display. More specifically, and without limitation, techniques disclosed herein relate to temporal dimming of the display and side shields of a head-mounted display to extend the lifetime of the display and reduce the power consumption of the head-mounted display. Various inventive embodiments are described herein, including devices, systems, structures, methods, algorithms, applications, program code, and the like.

According to certain embodiments, a head-mounted display system may include a near-eye display configured to present images to a user's eye, one or more side shields that are configured to fill gaps between the user's face and peripheries of the near-eye display and are dimmable using an electrical control signal, and a controller configured to control dimming of the near-eye display and the one or more side shields, where the one or more side shields are at least partially transparent to visible light.

According to certain embodiments, a processor-implemented method may include: obtaining a luminance level and/or a spectrum of ambient light of a head-mounted display (HMD) system using one or more ambient light sensors, gradually dimming a near-eye display of the HMD system without causing a noticeable change of perceived brightness by a user's eye, and, based at least in part on the luminance and/or spectrum of the ambient light of the HMD system, changing a transmissivity of one or more side shields that are dimmable using an electrical control signal and are configured to fill gaps between the user's face and peripheries of the near-eye display.

### BRIEF DESCRIPTION OF THE DRAWINGS

Illustrative embodiments are described in detail below with reference to the following figures.

FIG. 1 is a simplified block diagram of an example of an artificial reality system environment including a near-eye display.

FIG. 2 is a perspective view of an example of a near-eye display in the form of a head-mounted display (HMD) device for implementing some of the examples disclosed herein.

FIG. 3 is a perspective view of an example of a near-eye display in the form of a pair of glasses for implementing some of the examples disclosed herein.

FIG. 4 illustrates an example of an optical see-through augmented reality system including a waveguide display.

FIG. 5 illustrates an example of an image source assembly in an augmented reality system.

FIG. 6 illustrates examples of the sensitivity of human eyes as a function of the luminance level of the received light.

FIG. 7 illustrates examples of the response of human eyes as a function of the luminance level of the received light.

FIG. 8A shows an example of a temporal luminance change curve for increasing the luminance level as a function of time during a temporal dimming process according to certain embodiments.

FIG. 8B shows an example of a temporal luminance change curve for decreasing the luminance level as a function of time during a temporal dimming process according to certain embodiments.

FIG. 9 illustrates an example of a head-mounted display system including dimmable side shields according to certain embodiments.

FIG. 10 illustrates an example of a subsystem for temporal dimming in a head-mounted display system according to certain embodiments.

FIG. 11 includes a flowchart illustrating an example of a method of temporal dimming of a head-mounted display system according to certain embodiments.

FIG. 12 is a simplified block diagram of an electronic system of an example of a near-eye display according to certain embodiments.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

This disclosure relates generally to head-mounted display (HMD). More specifically, and without limitation, techniques disclosed herein relate to temporal dimming of the display and side shields of a head-mounted display to extend the lifetime of the display and reduce the power consumption of the head-mounted display. Various inventive embodiments are described herein, including devices, systems, structures, methods, algorithms, applications, program code, and the like.

Augmented reality (AR), virtual reality (VR), mixed reality (MR), and other artificial reality applications may use head-mounted display (HMD) systems to present images of virtual objects and/or real objects to the user's eyes. A head-mounted display generally includes an image source (e.g., a display panel) that is near the user’s eyes and can generate images to be viewed by the user. The head-mounted display may also include an optical system configured to relay the images generated by the image source to create virtual images that appear to be away from the image source and further than just a few centimeters away from the user's eyes. The image source of the head-mounted display may include, for example, a liquid crystal display (LCD), an organic light emitting diode (OLED) display, a micro-OLED display, an inorganic light emitting diode (ILED) display, a micro light emitting diode (micro-LED) display, an active-matrix OLED display (AMOLED), a transparent OLED display (TOLED), or another display. The optical system of the head-mounted display may include, for example, a lens (e.g., pancake lens) and/or an optical combiner such as a waveguide combiner, a partial reflector combiner, a prism birdbath combiner, a free-space birdbath combiner, and the like. It is generally desirable that the head-mounted display has a small size, a low weight, a large field of view, a large eye box, a high power efficiency, a high brightness, a high resolution, a high refresh rate, a low cost, a long battery life, and a long lifetime.

For example, power consumption may be a major challenge for head-mounted display systems. A head-mounted display is generally worn on a user’s head, and thus the weight constraint may be much more restrictive than other battery-powered portable electronic devices, such as cell phones or touch pads. Therefore, a head-mounted display may be constrained in the amount of power that can be used by the display device, and it is desirable that the head-mounted display can have a higher power efficiency to improve the battery life and/or reduce the weight of the head-mounted display. However, the display system (e.g., display panels) of an HMD may often need to have a high power consumption in order to provide bright, high-resolution, and high-refresh rate images with a large color gamut and a large field of view (FOV) to improve the immersive experience of using the head-mounted display. Therefore, the display system of an HMD may consume a large portion of the total power consumption of the HMD, where the remaining portions may be used by, for example, data processing. As such, saving a significant portion of the power used by the display system can greatly reduce the total power consumption of the HMD, and/or may free up battery budget for other tasks such as data processing, such that the HMDs may be lighter and more efficient, and can have a longer battery life between battery charging or replacement.

The amount of power consumption of the display system of an HMD may depend on several factors, such as the maximum brightness in the image, mean brightness or colors, and the like. Reducing the brightness of the displayed image may significantly reduce the power consumption of the display system. Therefore, one way to reduce the power consumption by the display system is to reduce the brightness of the pixels globally. Reducing the brightness of the pixels can also increase their lifetime (e.g., reducing pixel burnout), thereby increasing the overall lifespan of the display system. However, reducing the overall brightness of the pixels may negatively impact the user experience from an image quality perspective.

One way to mitigate the image quality impact of the reduced pixel brightness is dimming the brightness of the display slowly, overtime, which may be referred herein as "temporal dimming." When adequate time is given during the dimming process, the visual system of a human eye can adapt to the brightness changes, such that the user may not visually notice the overall change in the brightness of the display system. In general, for the temporal dimming to be effective in saving power and reducing system weight and size without negatively impact the image quality and user experience, the user's visual field may need to be isolated from the ambient environment, because the ambient environment may not dim temporally with the dimming of the display system. If the user can view the ambient environment that is not dimmed in any portion of the visual field, the temporal dimming of the display may reduce the brightness contrast of the display and reduce user's perceived brightness and image quality of the display, and thus may be perceptually noticeable. In some optical see-through HMDs (e.g., including waveguide displays), an active dimming element may be used in front of the optical see-through display (e.g., between the waveguide display and the ambient environment) to attenuate ambient light before it reaches the optical see-through display. However, in many augmented reality or mixed reality systems, the HMD systems may have open peripheries to allow the users to view objects in real world, such as other people, which may need the user's attention, thereby allowing for better mixed reality and shared experiences. Thus, with the open peripheries that may allow ambient light to reach user’s eyes, it may be difficult to applying the temporal dimming techniques in such augmented reality or mixed reality systems to dim the display system and reduce the power consumption of the display system, without negatively impact the image quality and user experience. For example, when the user moves from a darker environment to a brighter environment, the brightness of the display may need to be increased to match the brighter environment that may be viewed by the user through the open peripheries, in order to maintain a perceptually stable user experience. In addition, the user may notice a difference between the display white point (e.g., color temperature of the displayed image) and the environment white point (e.g., color temperature of the ambient light) because different lighting environments may have different white points (e.g., different color temperatures, such as cooler office light vs. warmer candlelight).

According to certain embodiments disclosed herein, in order to overcome the impact of the open peripheries of an HMD on the applicability and effectiveness of the temporal dimming techniques, dimmable, see-through side shields may be used in the HMD, where the side shields may include active dimming elements that may be controlled to synchronously dim with the display system. The active dimming elements may include, for example, electrochromic films, polymer-dispersed liquid crystal (PDLC) films, or other light dimming films that can change their transmissivity when the electrical signals applied to the films change. The controller for controlling the dimming of the display system may be used to control the dimming of the active dimming elements in the dimmable, see-through side shields, or may be synchronized with the controller for controlling the dimming of the active dimming elements. As the display system reduces its brightness over time (at a rate that may not be noticeable to the user), the active dimming elements of the side shields would reduce its transmissivity in a manner such that the surrounding environment is dimmed at a similar rate as the display system.

In some examples, the HMD may include one or more ambient light sensors that may estimate the ambient light intensity, such that the dimming of the active dimming elements may be determined based at least in part on the estimated ambient light intensity that may change over time. For example, when the user moves from a darker environment to a brighter environment, the active dimming elements in the side shields and/or in front of an optical see-through display of the HMD may be dimmed accordingly to attenuate the ambient light from the bright environment, such that the brightness of the display would not need to be increased to match the brighter environment in order to maintain a perceptually stable user experience. In some examples, the brightness and/or spectrum of light within the HMD (e.g., including display light and ambient light entering a region between the display and the user’s eyes) may be determined using various methods, such as based on pixel values (e.g., RGB values), device control voltage (e.g., pixel drive voltage), and/or device drive current (e.g., pixel drive current), and thus the dimming of the active dimming elements of the side shields may be determined based additionally or alternatively on the determined brightness and/or spectrum within the HMD. For example, light of certain wavelengths may be dynamically attenuated or blocked by the side shields based on the difference between the spectrum of the ambient light and the spectrum of the display light, in order to match the color temperature of the display and the color temperature of the perceived ambient light, thereby maintaining a stable perception of color. In some examples, the HMD may include an eye tracking or monitoring system that may detect the eye openness and the blinking of the user eye, and the brightness of the display system may be changed at larger steps or faster rates during the eye blinking without being noticed because the user's eye may be less sensitive to luminance change during a blink.

The addition and the coupling of the active dimming side shields to the temporal dimming display can mitigate the challenges of reducing display power consumption by temporal dimming in HMDs having open peripheries, such that the display systems of the HMDs can be temporally dimmed to reduce the display brightness and thus the power consumption, size, and/or weight of the HMD, without reducing the immersive user experience and the quality of the displayed images. For example, when the user moves from a darker environment to a brighter environment, the active dimming side shields may be dimmed accordingly to further attenuate the ambient light from the bright environment, such that the display would not need to be brighter to match the brighter environment in order to maintain a perceptually stable experience. Furthermore, the side shields may provide the benefit of maintaining the same white point (e.g., color temperature) within the HMD. The dimming of the display system enabled by the techniques disclosed herein may also improve the lifetime of the display system (e.g., reducing pixel burnout). Active dimming of the side shields may also be used as a signal to surrounding people in the ambient environment that the user of the HMD may be in "focus" mode or "do-not-disturb" mode. In addition, enclosing the display system with the side shields may help improve the visual comfort by reducing airflow through the eyebox that may otherwise increase symptoms such as dry eyes in open-periphery HMDs.

The techniques described herein may be used in conjunction with various technologies, such as an artificial reality system. An artificial reality system, such as a head-mounted display (HMD) or heads-up display (HUD) system, generally includes a display configured to present artificial images that depict objects in a virtual environment. The display may present virtual objects or combine images of real objects with virtual objects, as in virtual reality (VR), augmented reality (AR), or mixed reality (MR) applications. For example, in an AR system, a user may view both displayed images of virtual objects (e.g., computer-generated images (CGIs)) and the surrounding environment by, for example, seeing through transparent display glasses or lenses (often referred to as optical see-through) or viewing displayed images of the surrounding environment captured by a camera (often referred to as video see-through). In some AR systems, the artificial images may be presented to users using an LED-based display subsystem.

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

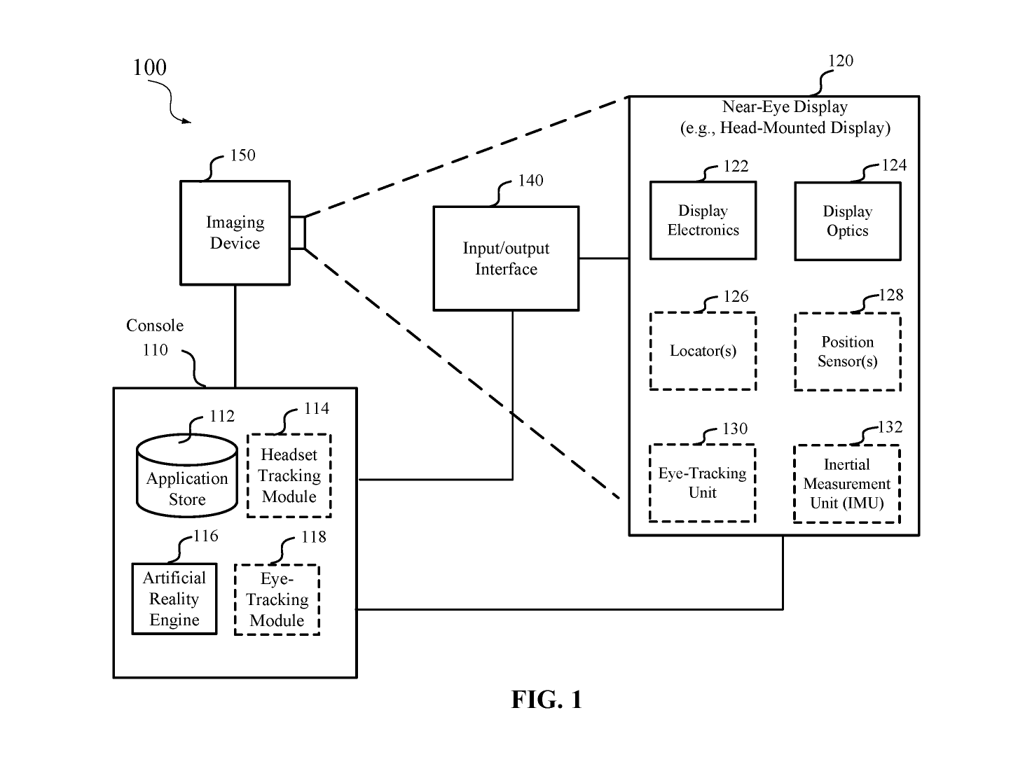

FIG. 1 is a simplified block diagram of an example of an artificial reality system environment 100 including a near-eye display 120 in accordance with certain embodiments. Artificial reality system environment 100 shown in FIG. 1 may include near-eye display 120, an optional external imaging device 150, and an optional input/output interface 140, each of which may be coupled to an optional console 110. While FIG. 1 shows an example of artificial reality system environment 100 including one near-eye display 120, one external imaging device 150, and one input/output interface 140, any number of these components may be included in artificial reality system environment 100, or any of the components may be omitted. For example, there may be multiple near-eye displays 120 monitored by one or more external imaging devices 150 in communication with console 110. In some configurations, artificial reality system environment 100 may not include external imaging device 150, optional input/output interface 140, and optional console 110. In alternative configurations, different or additional components may be included in artificial reality system environment 100.

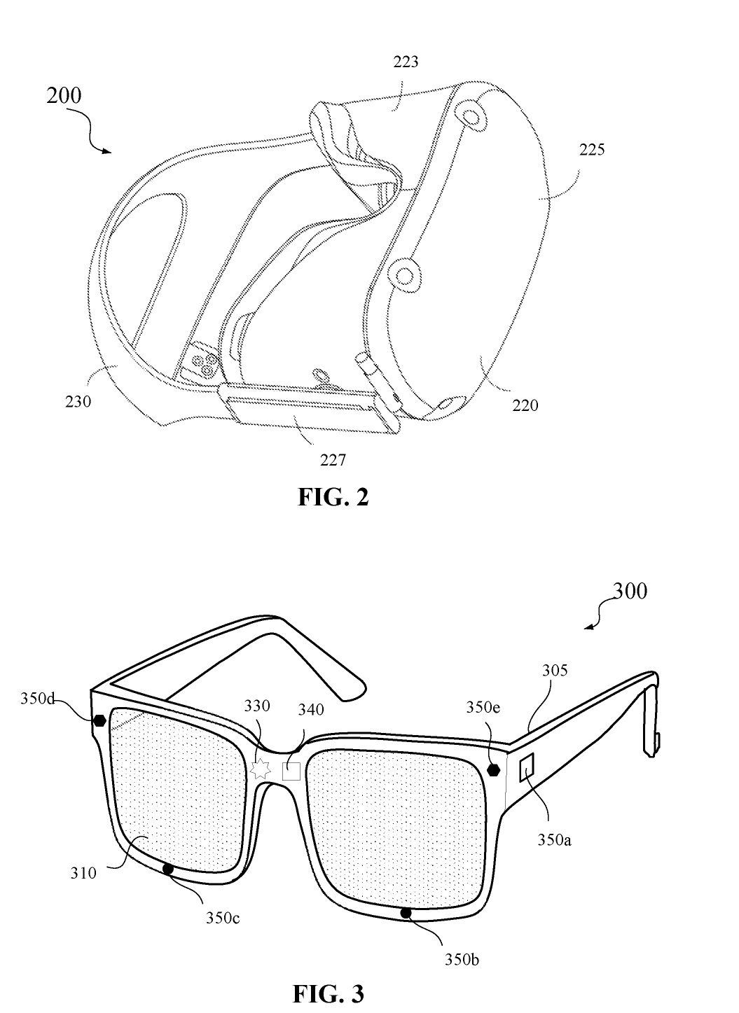

Near-eye display 120 may be a head-mounted display that presents content to a user. Examples of content presented by near-eye display 120 include one or more of images, videos, audio, or any combination thereof. In some embodiments, audio may be presented via an external device (e.g., speakers and/or headphones) that receives audio information from near-eye display 120, console 110, or both, and presents audio data based on the audio information. Near-eye display 120 may include one or more rigid bodies, which may be rigidly or non-rigidly coupled to each other. A rigid coupling between rigid bodies may cause the coupled rigid bodies to function as a single rigid entity. A non-rigid coupling between rigid bodies may allow the rigid bodies to move relative to each other. In various embodiments, near-eye display 120 may be implemented in any suitable form-factor, including a pair of glasses. Some embodiments of near-eye display 120 are further described below with respect to FIGS. 2 and 3. Additionally, in various embodiments, the functionality described herein may be used in a headset that combines images of an environment external to near-eye display 120 and artificial reality content (e.g., computer-generated images). Therefore, near-eye display 120 may augment images of a physical, real-world environment external to near-eye display 120 with generated content (e.g., images, video, sound, etc.) to present an augmented reality to a user.

In various embodiments, near-eye display 120 may include one or more of display electronics 122, display optics 124, and an eye-tracking unit 130. In some embodiments, near-eye display 120 may also include one or more locators 126, one or more position sensors 128, and an inertial measurement unit (IMU) 132. Near-eye display 120 may omit any of eye-tracking unit 130, locators 126, position sensors 128, and IMU 132, or include additional elements in various embodiments. Additionally, in some embodiments, near-eye display 120 may include elements combining the function of various elements described in conjunction with FIG. 1.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, an inorganic light emitting diode (ILED) display, a micro light emitting diode (μLED) display, an active-matrix OLED display (AMOLED), a transparent OLED display (TOLED), or some other display. For example, in one implementation of near-eye display 120, display electronics 122 may include a front TOLED panel, a rear display panel, and an optical component (e.g., an attenuator, polarizer, or diffractive or spectral film) between the front and rear display panels. Display electronics 122 may include pixels to emit light of a predominant color such as red, green, blue, white, or yellow. In some implementations, display electronics 122 may display a three-dimensional (3D) image through stereoscopic effects produced by two-dimensional panels to create a subjective perception of image depth. For example, display electronics 122 may include a left display and a right display positioned in front of a user’s left eye and right eye, respectively. The left and right displays may present copies of an image shifted horizontally relative to each other to create a stereoscopic effect (i.e., a perception of image depth by a user viewing the image).

In certain embodiments, display optics 124 may display image content optically (e.g., using optical waveguides and couplers) or magnify image light received from display electronics 122, correct optical errors associated with the image light, and present the corrected image light to a user of near-eye display 120. In various embodiments, display optics 124 may include one or more optical elements, such as, for example, a substrate, optical waveguides, an aperture, a Fresnel lens, a convex lens, a concave lens, a filter, input/output couplers, or any other suitable optical elements that may affect image light emitted from display electronics 122. Display optics 124 may include a combination of different optical elements as well as mechanical couplings to maintain relative spacing and orientation of the optical elements in the combination. One or more optical elements in display optics 124 may have an optical coating, such as an antireflective coating, a reflective coating, a filtering coating, or a combination of different optical coatings.

Locators 126 may be objects located in specific positions on near-eye display 120 relative to one another and relative to a reference point on near-eye display 120. In some implementations, console 110 may identify locators 126 in images captured by external imaging device 150 to determine the artificial reality headset’s position, orientation, or both. A locator 126 may be an LED, a corner cube reflector, a reflective marker, a type of light source that contrasts with an environment in which near-eye display 120 operates, or any combination thereof. In embodiments where locators 126 are active components (e.g., LEDs or other types of light emitting devices).

External imaging device 150 may include one or more cameras, one or more video cameras, any other device capable of capturing images including one or more of locators 126, or any combination thereof. Additionally, external imaging device 150 may include one or more filters (e.g., to increase signal to noise ratio). External imaging device 150 may be configured to detect light emitted or reflected from locators 126 in a field of view of external imaging device 150. In embodiments where locators 126 include passive elements (e.g., retroreflectors), external imaging device 150 may include a light source that illuminates some or all of locators 126, which may retro-reflect the light to the light source in external imaging device 150. Slow calibration data may be communicated from external imaging device 150 to console 110, and external imaging device 150 may receive one or more calibration parameters from console 110 to adjust one or more imaging parameters (e.g., focal length, focus, frame rate, sensor temperature, shutter speed, aperture, etc.).

Position sensors 128 may generate one or more measurement signals in response to motion of near-eye display 120. Examples of position sensors 128 may include accelerometers, gyroscopes, magnetometers, other motion-detecting or error-correcting sensors, or any combination thereof. For example, in some embodiments, position sensors 128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 132 may be an electronic device that generates fast calibration data based on measurement signals received from one or more of position sensors 128. Position sensors 128 may be located external to IMU 132, internal to IMU 132, or any combination thereof. Based on the one or more measurement signals from one or more position sensors 128, IMU 132 may generate fast calibration data indicating an estimated position of near-eye display 120 relative to an initial position of near-eye display 120.

Eye-tracking unit 130 may include one or more eye-tracking systems. Eye tracking may refer to determining an eye’s position, including orientation and location of the eye, relative to near-eye display 120. An eye-tracking system may include an imaging system to image one or two eyes and may optionally include a light emitter, which may generate light that is directed to an eye such that light reflected by the eye may be captured by the imaging system. Near-eye display 120 may use the orientation of the eye to, e.g., determine an inter-pupillary distance (IPD) of the user, determine gaze direction, introduce depth cues (e.g., blur image outside of the user’s main line of sight), collect heuristics on the user interaction in the VR media (e.g., time spent on any particular subject, object, or frame as a function of exposed stimuli), some other functions that are based in part on the orientation of at least one of the user’s eyes, or any combination thereof.

Input/output interface 140 may be a device that allows a user to send action requests to console 110. An action request may be a request to perform a particular action. For example, an action request may be to start or to end an application or to perform a particular action within the application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. In some embodiments, external imaging device 150 may be used to track input/output interface 140, such as tracking the location or position of a controller (which may include, for example, an IR light source) or a hand of the user to determine the motion of the user. In some embodiments, near-eye display 120 may include one or more imaging devices to track input/output interface 140, such as tracking the location or position of a controller or a hand of the user to determine the motion of the user.

Console 110 may provide content to near-eye display 120 for presentation to the user in accordance with information received from one or more of external imaging device 150, near-eye display 120, and input/output interface 140. In the example shown in FIG. 1, console 110 may include an application store 112, a headset tracking module 114, an artificial reality engine 116, and an eye-tracking module 118. Some embodiments of console 110 may include different or additional modules than those described in conjunction with FIG. 1. Functions further described below may be distributed among components of console 110 in a different manner than is described here.

In some embodiments, console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In various embodiments, the modules of console 110 described in conjunction with FIG. 1 may be encoded as instructions in the non-transitory computer-readable storage medium that, when executed by the processor, cause the processor to perform the functions further described below.

Application store 112 may store one or more applications for execution by console 110. An application may include a group of instructions that, when executed by a processor, generates content for presentation to the user. Content generated by an application may be in response to inputs received from the user via movement of the user’s eyes or inputs received from the input/output interface 140. Examples of the applications may include gaming applications, conferencing applications, video playback application, or other suitable applications.

Headset tracking module 114 may track movements of near-eye display 120 using slow calibration information from external imaging device 150. For example, headset tracking module 114 may determine positions of a reference point of near-eye display 120 using observed locators from the slow calibration information and a model of near-eye display 120. Headset tracking module 114 may also determine positions of a reference point of near-eye display 120 using position information from the fast calibration information. Additionally, in some embodiments, headset tracking module 114 may use portions of the fast calibration information, the slow calibration information, or any combination thereof, to predict a future location of near-eye display 120. Headset tracking module 114 may provide the estimated or predicted future position of near-eye display 120 to artificial reality engine 116.

Artificial reality engine 116 may execute applications within artificial reality system environment 100 and receive position information of near-eye display 120, acceleration information of near-eye display 120, velocity information of near-eye display 120, predicted future positions of near-eye display 120, or any combination thereof from headset tracking module 114. Artificial reality engine 116 may also receive estimated eye position and orientation information from eye-tracking module 118. Based on the received information, artificial reality engine 116 may determine content to provide to near-eye display 120 for presentation to the user. Artificial reality engine 116 may perform an action within an application executing on console 110 in response to an action request received from input/output interface 140, and provide feedback to the user indicating that the action has been performed. The feedback may be visual or audible feedback via near-eye display 120 or haptic feedback via input/output interface 140.

Eye-tracking module 118 may receive eye-tracking data from eye-tracking unit 130 and determine the position of the user’s eye based on the eye tracking data. The position of the eye may include an eye’s orientation, location, or both relative to near-eye display 120 or any element thereof. Because the eye’s axes of rotation change as a function of the eye’s location in its socket, determining the eye’s location in its socket may allow eye-tracking module 118 to determine the eye’s orientation more accurately.

FIG. 2 is a perspective view of an example of a near-eye display in the form of an HMD device 200 for implementing some of the examples disclosed herein. HMD device 200 may be a part of, e.g., a VR system, an AR system, an MR system, or any combination thereof. HMD device 200 may include a body 220 and a head strap 230. FIG. 2 shows a bottom side 223, a front side 225, and a left side 227 of body 220 in the perspective view. Head strap 230 may have an adjustable or extendible length. There may be a sufficient space between body 220 and head strap 230 of HMD device 200 for allowing a user to mount HMD device 200 onto the user’s head. In various embodiments, HMD device 200 may include additional, fewer, or different components. For example, in some embodiments, HMD device 200 may include eyeglass temples and temple tips as shown in, for example, FIG. 3 below, rather than head strap 230.

HMD device 200 may present to a user media including virtual and/or augmented views of a physical, real-world environment with computer-generated elements. Examples of the media presented by HMD device 200 may include images (e.g., two-dimensional (2D) or three-dimensional (3D) images), videos (e.g., 2D or 3D videos), audio, or any combination thereof. The images and videos may be presented to each eye of the user by one or more display assemblies (not shown in FIG. 2) enclosed in body 220 of HMD device 200. In various embodiments, the one or more display assemblies may include a single electronic display panel or multiple electronic display panels (e.g., one display panel for each eye of the user). Examples of the electronic display panel(s) may include, for example, an LCD, an OLED display, an ILED display, a µLED display, an AMOLED, a TOLED, some other display, or any combination thereof. HMD device 200 may include two eye box regions.

In some implementations, HMD device 200 may include various sensors (not shown), such as depth sensors, motion sensors, position sensors, and eye tracking sensors. Some of these sensors may use a structured light pattern for sensing. In some implementations, HMD device 200 may include an input/output interface for communicating with a console. In some implementations, HMD device 200 may include a virtual reality engine (not shown) that can execute applications within HMD device 200 and receive depth information, position information, acceleration information, velocity information, predicted future positions, or any combination thereof of HMD device 200 from the various sensors. In some implementations, the information received by the virtual reality engine may be used for producing a signal (e.g., display instructions) to the one or more display assemblies. In some implementations, HMD device 200 may include locators (not shown, such as locators 126) located in fixed positions on body 220 relative to one another and relative to a reference point. Each of the locators may emit light that is detectable by an external imaging device.

FIG. 3 is a perspective view of an example of a near-eye display 300 in the form of a pair of glasses for implementing some of the examples disclosed herein. Near-eye display 300 may be a specific implementation of near-eye display 120 of FIG. 1, and may be configured to operate as a virtual reality display, an augmented reality display, and/or a mixed reality display. Near-eye display 300 may include a frame 305 and a display 310. Display 310 may be configured to present content to a user. In some embodiments, display 310 may include display electronics and/or display optics. For example, as described above with respect to near-eye display 120 of FIG. 1, display 310 may include an LCD display panel, an LED display panel, or an optical display panel (e.g., a waveguide display assembly).

Near-eye display 300 may further include various sensors 350a, 350b, 350c, 350d, and 350e on or within frame 305. In some embodiments, sensors 350a-350e may include one or more depth sensors, motion sensors, position sensors, inertial sensors, or ambient light sensors. In some embodiments, sensors 350a-350e may include one or more image sensors configured to generate image data representing different fields of views in different directions. In some embodiments, sensors 350a-350e may be used as input devices to control or influence the displayed content of near-eye display 300, and/or to provide an interactive VR/AR/MR experience to a user of near-eye display 300. In some embodiments, sensors 350a-350e may also be used for stereoscopic imaging.

In some embodiments, near-eye display 300 may further include one or more illuminators 330 to project light into the physical environment. The projected light may be associated with different frequency bands (e.g., visible light, infra-red light, ultra-violet light, etc.), and may serve various purposes. For example, illuminator(s) 330 may project light in a dark environment (or in an environment with low intensity of infra-red light, ultra-violet light, etc.) to assist sensors 350a-350e in capturing images of different objects within the dark environment. In some embodiments, illuminator(s) 330 may be used to project certain light patterns onto the objects within the environment. In some embodiments, illuminator(s) 330 may be used as locators, such as locators 126 described above with respect to FIG. 1.

In some embodiments, near-eye display 300 may also include a high-resolution camera 340. Camera 340 may capture images of the physical environment in the field of view. The captured images may be processed, for example, by a virtual reality engine (e.g., artificial reality engine 116 of FIG. 1) to add virtual objects to the captured images or modify physical objects in the captured images, and the processed images may be displayed to the user by display 310 for AR or MR applications.

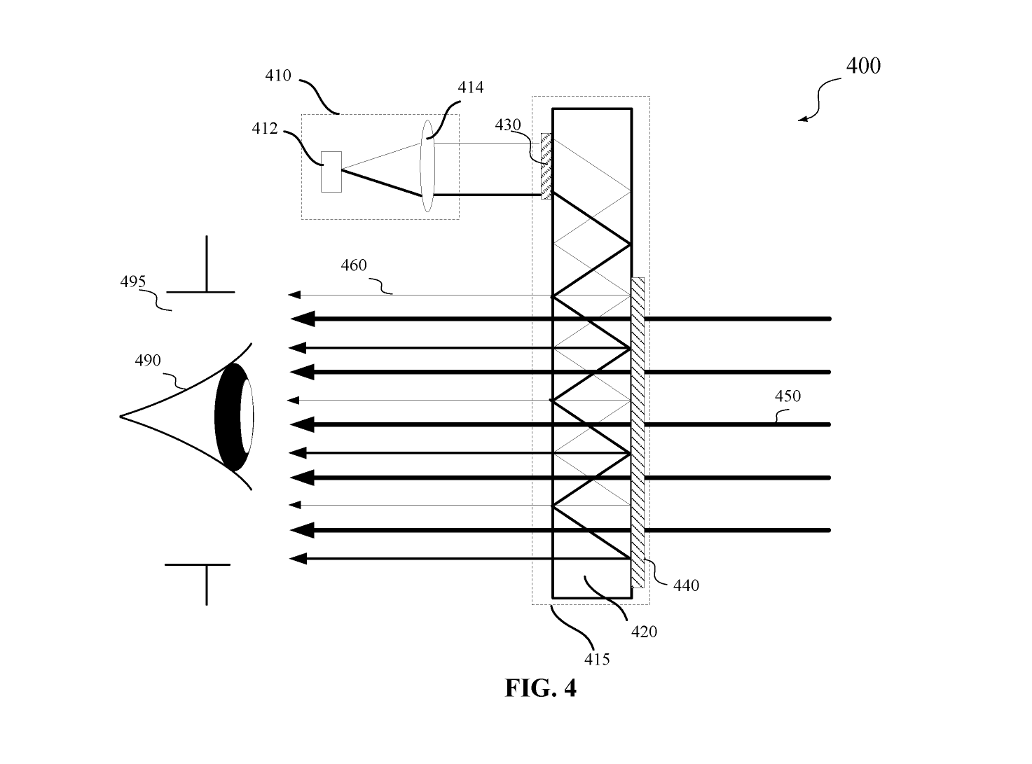

FIG. 4 illustrates an example of an optical see-through augmented reality system 400 including a waveguide display according to certain embodiments. Augmented reality system 400 may include a projector 410 and a combiner 415. Projector 410 may include a light source or image source 412 and projector optics 414. In some embodiments, light source or image source 412 may include one or more micro-LED devices described above. In some embodiments, image source 412 may include a plurality of pixels that displays virtual objects, such as an LCD display panel or an LED display panel. In some embodiments, image source 412 may include a light source that generates coherent or partially coherent light. For example, image source 412 may include a laser diode, a vertical cavity surface emitting laser, an LED, and/or a micro-LED described above. In some embodiments, image source 412 may include a plurality of light sources (e.g., an array of micro-LEDs described above), each emitting a monochromatic image light corresponding to a primary color (e.g., red, green, or blue). In some embodiments, image source 412 may include three two-dimensional arrays of micro-LEDs, where each two-dimensional array of micro-LEDs may include micro-LEDs configured to emit light of a primary color (e.g., red, green, or blue). In some embodiments, image source 412 may include an optical pattern generator, such as a spatial light modulator. Projector optics 414 may include one or more optical components that can condition the light from image source 412, such as expanding, collimating, scanning, or projecting light from image source 412 to combiner 415. The one or more optical components may include, for example, one or more lenses, liquid lenses, mirrors, apertures, and/or gratings. For example, in some embodiments, image source 412 may include one or more one-dimensional arrays or elongated two-dimensional arrays of micro-LEDs, and projector optics 414 may include one or more one-dimensional scanners (e.g., micro-mirrors or prisms) configured to scan the one-dimensional arrays or elongated two-dimensional arrays of micro-LEDs to generate image frames. In some embodiments, projector optics 414 may include a liquid lens (e.g., a liquid crystal lens) with a plurality of electrodes that allows scanning of the light from image source 412.

Combiner 415 may include an input coupler 430 for coupling light from projector 410 into a substrate 420 of combiner 415. Input coupler 430 may include a volume holographic grating, a diffractive optical element (DOE) (e.g., a surface-relief grating), a slanted surface of substrate 420, or a refractive coupler (e.g., a wedge or a prism). For example, input coupler 430 may include a reflective volume Bragg grating or a transmissive volume Bragg grating. Input coupler 430 may have a coupling efficiency of greater than 30%, 50%, 75%, 90%, or higher for visible light. Light coupled into substrate 420 may propagate within substrate 420 through, for example, total internal reflection (TIR). Substrate 420 may be in the form of a lens of a pair of eyeglasses. Substrate 420 may have a flat or a curved surface, and may include one or more types of dielectric materials, such as glass, quartz, plastic, polymer, poly(methyl methacrylate) (PMMA), crystal, or ceramic. A thickness of the substrate may range from, for example, less than about 1 mm to about 10 mm or more. Substrate 420 may be transparent to visible light.

Substrate 420 may include or may be coupled to a plurality of output couplers 440, each configured to extract at least a portion of the light guided by and propagating within substrate 420 from substrate 420, and direct extracted light 460 to an eyebox 495 where an eye 490 of the user of augmented reality system 400 may be located when augmented reality system 400 is in use. The plurality of output couplers 440 may replicate the exit pupil to increase the size of eyebox 495 such that the displayed image is visible in a larger area. As input coupler 430, output couplers 440 may include grating couplers (e.g., volume holographic gratings or surface-relief gratings), other diffraction optical elements (DOEs), prisms, etc. For example, output couplers 440 may include reflective volume Bragg gratings or transmissive volume Bragg gratings. Output couplers 440 may have different coupling (e.g., diffraction) efficiencies at different locations. Substrate 420 may also allow light 450 from the environment in front of combiner 415 to pass through with little or no loss. Output couplers 440 may also allow light 450 to pass through with little loss. For example, in some implementations, output couplers 440 may have a low diffraction efficiency for light 450 such that light 450 may be refracted or otherwise pass through output couplers 440 with little loss, and thus may have a higher intensity than extracted light 460. In some implementations, output couplers 440 may have a high diffraction efficiency for light 450 and may diffract light 450 in certain desired directions (i.e., diffraction angles) with little loss. As a result, the user may be able to view combined images of the environment in front of combiner 415 and images of virtual objects projected by projector 410.

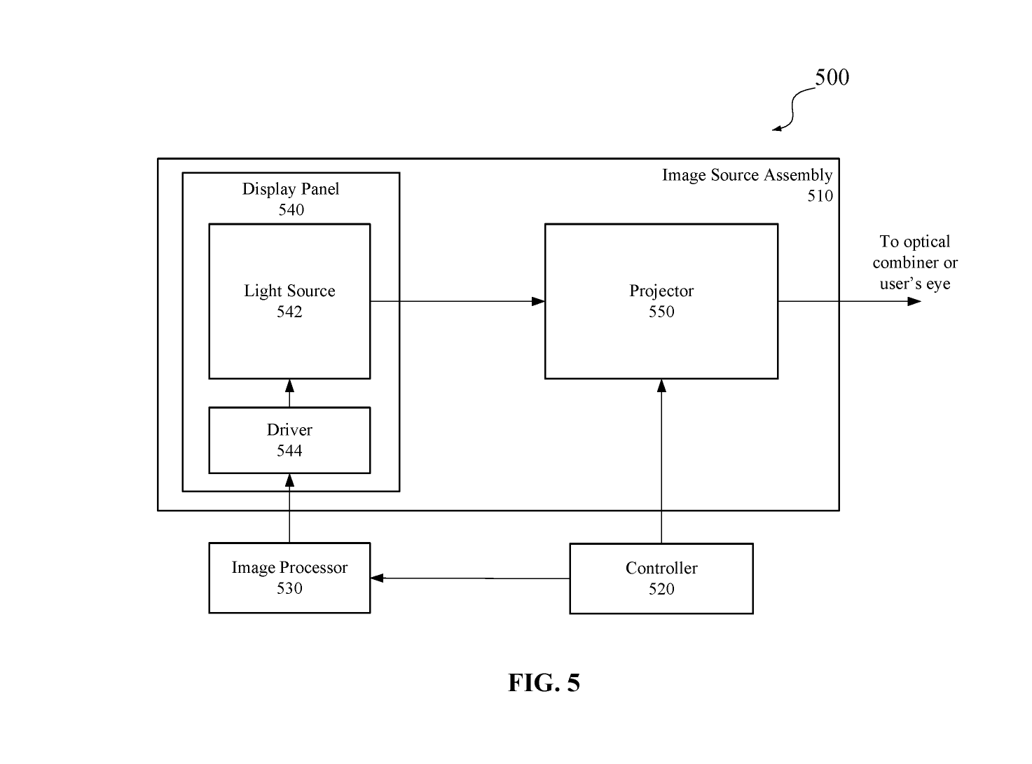

FIG. 5 illustrates an example of an image source assembly 510 in a near-eye display system 500 according to certain embodiments. Image source assembly 510 may include, for example, a display panel 540 that may generate display images to be projected to the user’s eyes, and a projector 550 that may project the display images generated by display panel 540 to the user's eyes directly or through an optical combiner (e.g., a waveguide display) as described above with respect to FIG. 4. Display panel 540 may include a light source 542 and a drive circuit 544 for light source 542. Light source 542 may include, for example, light source 412. Projector 550 may include, for example, a freeform optical element, a scanning mirror. Near-eye display system 500 may also include a controller 520 that synchronously controls light source 542 and projector 550. Image source assembly 510 may generate and output an image light to the user's eye directly, or may output the image light to an optical combiner (not shown in FIG. 5) such as a waveguide display, a partial reflective mirror, a birdbath combiner, and the like. As described above, a waveguide display may receive the image light at one or more input-coupling elements, and guide the received image light to one or more output-coupling elements. The input and output coupling elements may include, for example, a diffraction grating, a holographic grating, a prism, or any combination thereof. The input-coupling element may be chosen such that total internal reflection occurs with the waveguide display. The output-coupling element may couple portions of the total internally reflected image light out of the waveguide display.

As described above, light source 542 may include a plurality of light emitters arranged in an array or a matrix. Each light emitter may emit monochromatic light, such as red light, blue light, green light, infra-red light, and the like. While RGB colors are often discussed in this disclosure, embodiments described herein are not limited to using red, green, and blue as primary colors. Other colors can also be used as the primary colors of near-eye display system 500. In some embodiments, a display panel in accordance with an embodiment may use more than three primary colors. Each pixel in light source 542 may include three subpixels that include a red micro-LED, a green micro-LED, and a blue micro-LED. A semiconductor LED generally includes an active light emitting layer within multiple layers of semiconductor materials. The multiple layers of semiconductor materials may include different compound materials or a same base material with different dopants and/or different doping densities. For example, the multiple layers of semiconductor materials may include an n-type material layer, an active region that may include hetero-structures (e.g., one or more quantum wells), and a p-type material layer. The multiple layers of semiconductor materials may be grown on a surface of a substrate having a certain orientation.

Controller 520 may control the image rendering operations of image source assembly 510, such as the operations of light source 542 and/or projector 550. For example, controller 520 may determine instructions for image source assembly 510 to render one or more display images. The instructions may include display instructions and/or scanning instructions. In some embodiments, the display instructions may include an image file (e.g., a bitmap file). The display instructions may be received from, for example, a console, such as console 110 described above with respect to FIG. 1. The scanning instructions may be used by image source assembly 510 to generate image light using a scanning light beam. The scanning instructions may specify, for example, a type of a source of image light (e.g., monochromatic or polychromatic), a scanning rate, an orientation of a scanning apparatus, one or more illumination parameters, or any combination thereof. Controller 520 may include a combination of hardware, software, and/or firmware not shown here so as not to obscure other aspects of the present disclosure. In some embodiments, controller 520 may be a graphics processing unit (GPU) of a display device. In other embodiments, controller 520 may be other kinds of processors. In some embodiments, the operations performed by controller 520 may include taking content for display and dividing the content into discrete sections.

Image processor 530 may be a general-purpose processor and/or one or more application-specific circuits that are dedicated to performing the features described herein. In one embodiment, a general-purpose processor may be coupled to a memory to execute software instructions that cause the processor to perform certain processes described herein. In another embodiment, image processor 530 may be one or more circuits that are dedicated to performing certain features. While image processor 530 in FIG. 5 is shown as a stand-alone unit that is separate from controller 520 and drive circuit 544, image processor 530 may be a sub-unit of controller 520 or drive circuit 544 in other embodiments. In other words, in those embodiments, controller 520 or drive circuit 544 may perform various image processing functions of image processor 530. Image processor 530 may also be referred to as an image processing circuit.

In the example shown in FIG. 5, light source 542 may be driven by drive circuit 544, based on data or instructions sent from controller 520 or image processor 530. In one embodiment, drive circuit 544 may include a circuit panel that connects to and mechanically holds various light emitters of light source 542. Light source 542 may emit light in accordance with one or more illumination parameters that are set by the controller 520 and potentially adjusted by image processor 530 and drive circuit 544. An illumination parameter may be used by light source 542 to generate light. An illumination parameter may include, for example, source wavelength, pulse rate, pulse amplitude, beam type (continuous or pulsed), other parameter(s) that may affect the emitted light, or any combination thereof. In some embodiments, the source light generated by light source 542 may include multiple beams of red light, green light, and blue light, or any combination thereof.

Projector 550 may perform a set of optical functions, such as focusing, combining, conditioning, or scanning the image light generated by light source 542. In some embodiments, projector 550 may include a combining assembly, a light conditioning assembly, or a scanning mirror/prism assembly. Projector 550 may include one or more optical components that optically adjust and potentially re-direct the light from light source 542. One example of the adjustment of light may include conditioning the light, such as expanding, collimating, correcting for one or more optical errors (e.g., field curvature, chromatic aberration, etc.), some other adjustments of the light, or any combination thereof. The optical components of projector 550 may include, for example, lenses, mirrors, apertures, gratings, or any combination thereof. Projector 550 may redirect image light via its one or more reflective and/or refractive portions so that the image light is projected at certain orientations toward the user's eye or an optical combiner such as a waveguide display as described above. In some embodiments, projector 550 includes one or more scanning mirrors or prisms that may perform a raster scan (horizontally or vertically), a bi-resonant scan, or any combination thereof.

As described above, it is generally desirable that the head-mounted display has a small size, a low weight, a large field of view, a large eye box, a high power efficiency, a high brightness, a high resolution, a high refresh rate, a low cost, a long battery life, and a long lifetime. For example, power consumption may be a major challenge for head-mounted display systems. A head-mounted display is generally worn on a user’s head, and thus the weight constraint may be much more restrictive than other battery-powered portable electronic devices, such as cell phones or touch pads. Therefore, a head-mounted display may be constrained in the amount of power that can be used by the display device, and it is desirable that the head-mounted display can have a higher power efficiency to improve the battery life and/or reduce the weight of the head-mounted display. However, the display system (e.g., display panels) of an HMD may often need to have a high power consumption in order to provide bright, high-resolution, and high-refresh rate images with a large color gamut and a large field of view (FOV) to improve the immersive experience of using the head-mounted display. Therefore, the display system of an HMD may consume a large portion of the total power consumption of the HMD, where the remaining portions may be used by, for example, data processing. As such, saving a significant portion of the power used by the display system can greatly reduce the total power consumption of the HMD, and/or may free up battery budget for other tasks such as data processing, such that the HMDs may be lighter and more efficient, and can have a longer battery life between battery charging or replacement.

The amount of power consumption of the display system of an HMD may depend on several factors, such as the maximum brightness in the image, mean brightness or colors, and the like. Reducing the brightness of the displayed image may significantly reduce the power consumption of the display system. Therefore, one way to reduce the power consumption by the display system is to reduce the brightness of the pixels globally. Reducing the brightness of the pixels can also increase their lifetime (e.g., reducing pixel burnout), thereby increasing the overall lifespan of the display system. However, reducing the overall brightness of the pixels may negatively impact the user experience from an image quality perspective.

Human vision involves the interactions of two eyes and the brain through a network of neurons, receptors, and other specialized cells. The human visual process may include the stimulation of light receptors in the eyes, conversion of the light stimuli or images into electrical signals by the light receptors, transmission of the electrical signals containing the vision information from each eye to the visual cortices of the cerebrum of the brain through the optic nerves, and processing of the electrical signals by the brain. Human eyes have two types of photoreceptors – rod cells and cone cells. Cone cells may mainly be in the central portion of the retina (fovea), may be responsible for photopic vision (bright-light vision) and color perception, and can resolve fine details. Rod cells may be distributed over the entire retina, and may be responsible for scotopic vision (dim-light vision). The light sensitivity of rod cells can be about 1,000 times of that of the cone cells, but rod cells may respond much slower than cone cells. Rod cells may contain only the photopigment rhodopsin and thus are not color sensitive, and may provide the overall picture, but not the details of the picture.

Human eye can respond to a wide range of light intensity levels that may span over 10 orders of magnitude or 10 units on logarithmic scale. For example, in broad daylight, human eyes can visualize objects in the glaring light from the sun, while at threshold sensitivity, human eyes can reliably detect the presence of about 100-150 photons of blue-green light (e.g., around 500 nm) entering the pupil. But human eyes would not simultaneously discriminate such a wide range of intensity levels. To achieve such a wide sensing range, the human eyes do not respond to all light intensity levels linearly and simultaneously, and the perceived brightness does not increase linearly with the increase of the light intensity level (luminance level). Rather, the perceived brightness (subjective brightness) may be a logarithmic function of light intensity, and human eyes may adjust their response to the luminance level through brightness adaptation, whether the luminance level is increasing or decreasing. The brightness adaptation may be accomplished by changing the sensitivity of the cells (e.g., the rod cells and cone cells) at different adaptation levels, such as reducing the cells’ sensitivity to light as the background light level increases and increasing the cells' sensitivity to light as the background light level decreases, such that the cells may have higher sensitivity at lower luminance levels and lower sensitivity at higher luminance levels to avoid saturation. The brightness adaptation can occur within seconds for photopic vision, or within minutes for scotopic vision.

At any given adaptation level, the eye may only simultaneously discriminate a smaller range of intensity levels (e.g., within about three to five orders of magnitude). Intensity levels below this range may be perceived as black, whereas the eye may adapt to a different adaptation level (and a different sensitivity) for intensity levels above this range. In addition, at any given adaptation level and luminance level I, a change in the luminance level that can be noticed by the human eyes may need to be greater than a minimum or threshold change D I. The ability of human eyes to discriminate between changes in brightness levels may be referred to as brightness discrimination, and the minimum change D I in the luminance level for the human eyes to notice the change in the luminance level I may be referred to as the discrimination threshold or increment threshold. When the discrimination threshold or increment threshold of an eye is smaller, the eye has a better brightness discrimination. When a change in the luminance level is less than the discrimination threshold or increment threshold of the eye, the change may not be noticeable by the eye.

For photopic vision, the discrimination threshold or increment threshold of an eye may be determined based on, for example, the Weber's law or Weber-Fechner law, which describes the general relationship between an initial intensity I (or another parameter) and the smallest detectable increment D I. In general, the smallest detectable increment may change with the initial intensity I according to K=DI/I, where K is the Weber fraction that may be close to a constant for photopic vision and may have different values for rod cells and cone cells. For higher initial intensity I, the smallest detectable increment D I may be larger.

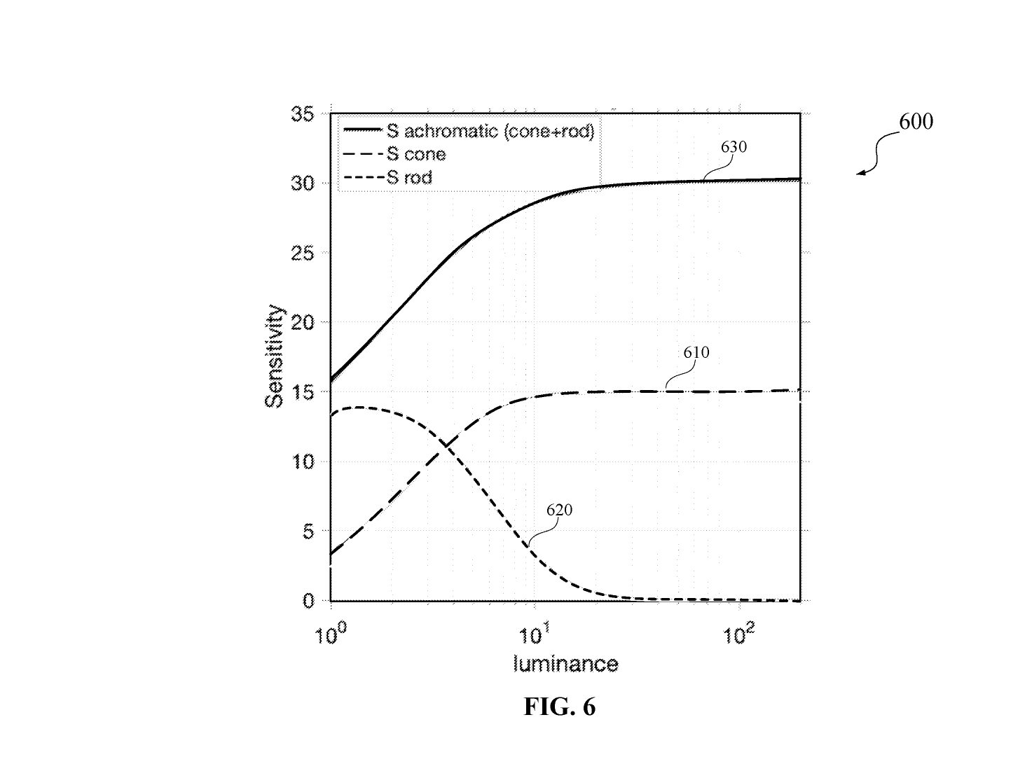

FIG. 6 includes a diagram 600 illustrating examples of the sensitivity of human eyes as a function of the luminance level of the received light. The sensitivity of the human eyes may be an inverse of the discrimination threshold. In FIG. 6, the horizontal axis corresponds to the luminance level in logarithmic scale, and the vertical axis corresponds to the sensitivity of the human eyes. A curve 610 shows the sensitivity of the cone cells of human eyes at different luminance levels. Curve 610 shows that the sensitivity of the cone cells may be low at low luminance levels, and may gradually increase as the luminance level increases. The sensitivity of the cone cells may be approximately constant for high luminance levels. A curve 620 in FIG. 6 shows the sensitivity of the rod cells of human eyes at different luminance levels. Curve 620 shows that the sensitivity of the cone cells may be high at low luminance level, and may gradually decrease as the luminance level increases. The sensitivity of the rod cells may be very low for high luminance levels, which indicates that rod cells may not be able to distinguish luminance level changes when the luminance level is high. A curve 630 shows the overall achromatic sensitivity of the human eyes at different luminance levels. Curve 630 shows that the overall achromatic sensitivity of the human eyes may be similar to the sensitivity of the rod cells at low luminance levels, and may gradually increase as the luminance level increases. The overall achromatic sensitivity of the human eyes may be approximately constant at high luminance levels.

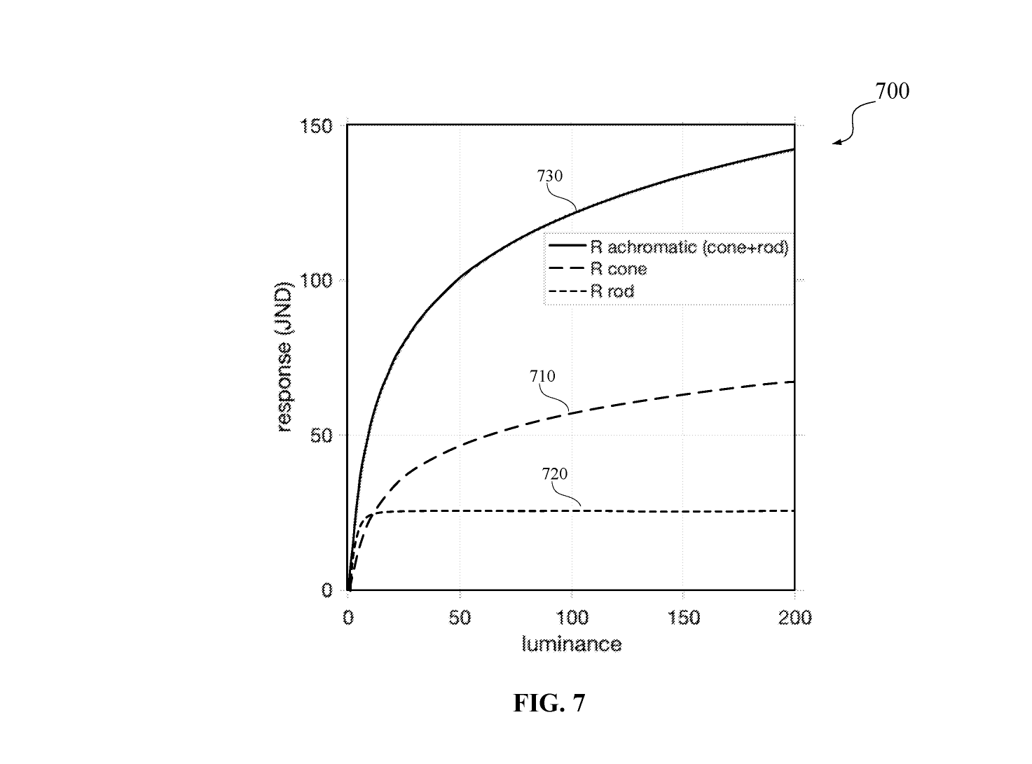

FIG. 7 includes a diagram 700 illustrating examples of the response of human eyes as a function of the luminance level of the received light. FIG. 7 shows the nonlinear response of human eyes to luminance. In FIG. 7, the horizontal axis corresponds to the luminance level, and the vertical axis corresponds to how well the human eye notices changes in luminance in just noticeable difference (JND) units. The just noticeable differences (JNDs) may be used to distribute the perceived brightness contrast evenly throughout the entire luminance range. The number of JNDs may correspond to the number of perceivable changes. The change of the response by one JND may indicate a just noticeable change of the luminance.

A curve 710 in FIG. 7 shows the response of the cone cells of human eyes to different luminance levels. Curve 710 indicates that the response (in JNDs) or the perceived brightness of cone cells may increase quickly as the luminance level increases when the luminance level is low, and may increase slowly as the luminance level increases when the luminance level is higher. A curve 720 in FIG. 7 shows the response of the rod cells of human eyes to different luminance levels. Curve 720 indicates that the response (in JNDs) or the perceived brightness of rod cells may increase quickly as the luminance level increases when the luminance level is low, but may not increase as the luminance level increases when the luminance level is high. A curve 730 shows the overall achromatic response of the human eyes at different initial luminance levels. Curve 730 shows that the overall achromatic response of the human eyes may increase quickly as the luminance level increases when the luminance level is low, and may increase slowly as the luminance level increases when the luminance level is higher.

Due to the light adaptation capability of human eyes described above, the impact on image quality (e.g., brightness contrast) by the reduced pixel brightness may be mitigated by dimming the brightness of the display slowly (e.g., at a small increment or decrement such as less than one JND), over a sufficiently long time period so that the eyes may adapt to the gradual change in the luminance level. This technique may be referred to herein as "temporal dimming". The brightness adaptation of human eyes to small changes can be fast for both light intensity increment (e.g., about 50 ms) and light intensity decrement (e.g., about 200 ms), and may depend on the luminance level before the adaptation. When adequate time is given during the dimming (e.g., for each dimming step), the human visual system can adapt to the brightness changes, such that the user may not visually notice the overall change in the brightness of the display system during the temporal dimming process. Therefore, a temporal brightness change curve specifying the luminance level at any given time during a temporal dimming process may be determined based on, for example, the initial luminance level, the end luminance level, and the discrimination threshold and the adaptation time at each luminance level of a plurality of luminance levels between the initial luminance level and the end luminance level. The luminance level of the display system at different time during the temporal dimming process may be set based on the temporal brightness change curve, to reduce the impact on image quality by the reduced pixel brightness.

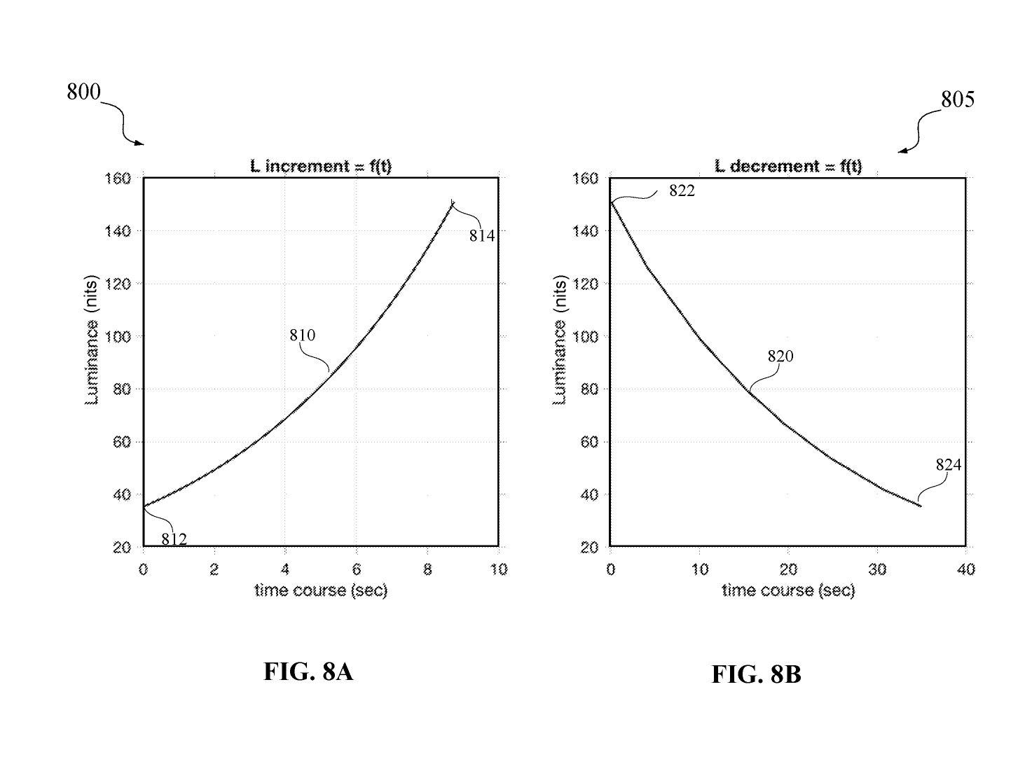

FIG. 8A includes a diagram 800 showing an example of a temporal luminance change curve for increasing the luminance level as a function of time during a temporal dimming process according to certain embodiments. A curve 810 in FIG. 8A shows that the luminance level (in nits) of a display may be gradually increased from a low level 812 to a high level 814 according to curve 810 in about 8 seconds, and the change may be adapted by the user's eyes during the temporal dimming process to not cause any noticeable change in the perceived brightness. For example, the luminance level may be increased at slower rates when the luminance levels are lower, and may be increased at higher rates when the luminance levels are higher.

FIG. 8B includes a diagram 805 showing an example of a temporal luminance change curve for decreasing the luminance level as a function of time during a temporal dimming process according to certain embodiments. A curve 820 in FIG. 8B shows that the luminance level of a display may be gradually decreased from a high level 822 to a low level 824 according to curve 820 in about 35 seconds, and the change may be adapted by the user's eyes during the temporal dimming process to not cause any noticeable change in the perceived brightness. For example, the luminance level may be decreased at higher rates when the luminance levels are higher, and may be decreased at lower rates when the luminance levels are lower.

For the temporal dimming to be effective in saving power and reducing system weight and size without negatively impact the image quality and user experience, the user's visual field may need to be isolated from the ambient environment, because the ambient environment may not be dimming temporally with the dimming of the display system. If the user can view the ambient environment that is not dimmed in any portion of the visual field, the temporal dimming of the display may reduce the brightness contrast of the display, reduce user's perceived brightness and image quality of the display, and become noticeable. For example, in many augmented reality or mixed reality systems, the HMD systems may have open peripheries to allow the users to view objects in real world (e.g., other people) that may need the user's attention, thereby allowing for better mixed reality and shared experiences. Thus, it may be difficult to applying the temporal dimming techniques in such augmented reality or mixed reality systems to dim the display system and reduce the power consumption of the display system, without negatively impact the image quality and user experience. In addition, the user may notice a difference between the display white point (e.g., color temperature) and the environment white point because different lighting environments may have different white points (e.g., cooler office light vs. warmer candlelight).

According to certain embodiments disclosed herein, in order to overcome the impact of the open peripheries of an HMD on the applicability and effectiveness of the temporal dimming techniques, dimmable, see-through side shields may be used in the HMD, where the side shields may include active dimming elements that may be controlled to synchronously dim with the display system. In some optical see-through HMDs, one or more active dimming elements may also be used in front of the optical see-through display (e.g., between the optical see-through display and the ambient environment) to attenuate ambient light before the ambient light reaches the optical see-through display. The active dimming elements may include, for example, electrochromic films, polymer-dispersed liquid crystal (PDLC) films, or other light dimming films that can change their transmissivity when the electrical signals applied to the films change. The controller for controlling the dimming of the display system may be used to control the dimming of the active dimming elements in the dimmable, see-through side shields, or may be synchronized with the controller for controlling the dimming of the active dimming elements. As the display system reduces its brightness over time (at a rate that may not be noticeable to the user), the active dimming elements of the side shields would reduce its transmissivity in a manner such that the surrounding environment is dimmed at a similar rate as the display system.

In some examples, the HMD may include one or more ambient light sensors that may estimate the ambient light intensity and/or spectrum, such that the dimming of the active dimming elements may be determined based on the estimated ambient light intensity and/or spectrum that may change over time. For example, when the user moves from a darker environment to a brighter environment, the active dimming elements in the side shields and/or in front of the display may be dimmed accordingly to attenuate the ambient light from the bright environment, such that the display would not need to be brighter to match the brighter environment in order to maintain a perceptually stable experience. In some examples, the brightness and/or spectrum of light within the HMD (e.g., including display light and ambient light entering a region between the display and the user’s eyes) may be determined using various methods, such as based on the pixel values (e.g., RGB values), device control voltage (e.g., pixel drive voltage), or device drive current (e.g., pixel drive current), and the dimming of the active dimming elements of the side shields may be determined based on the estimated ambient light intensity and/or spectrum, the determined brightness and/or spectrum of light within the HMD, or both the estimated ambient light intensity and/or spectrum and the determined brightness and/or spectrum of the light within the HMD. For example, the active dimming elements may be controlled to dynamically attenuated or blocked light of some wavelengths to control the white point (e.g., color temperature) of the ambient light entering the HMD and perceived by the user, thereby maintaining a stable perception of color. In some examples, the HMD may include an eye tracking or monitoring system that may detect the eye openness and the blinking of the user eye, and the brightness of the display system may be changed at larger steps or faster rates during the eye blinking without being noticed because the user's eye may be less sensitive to luminance change during a blink.

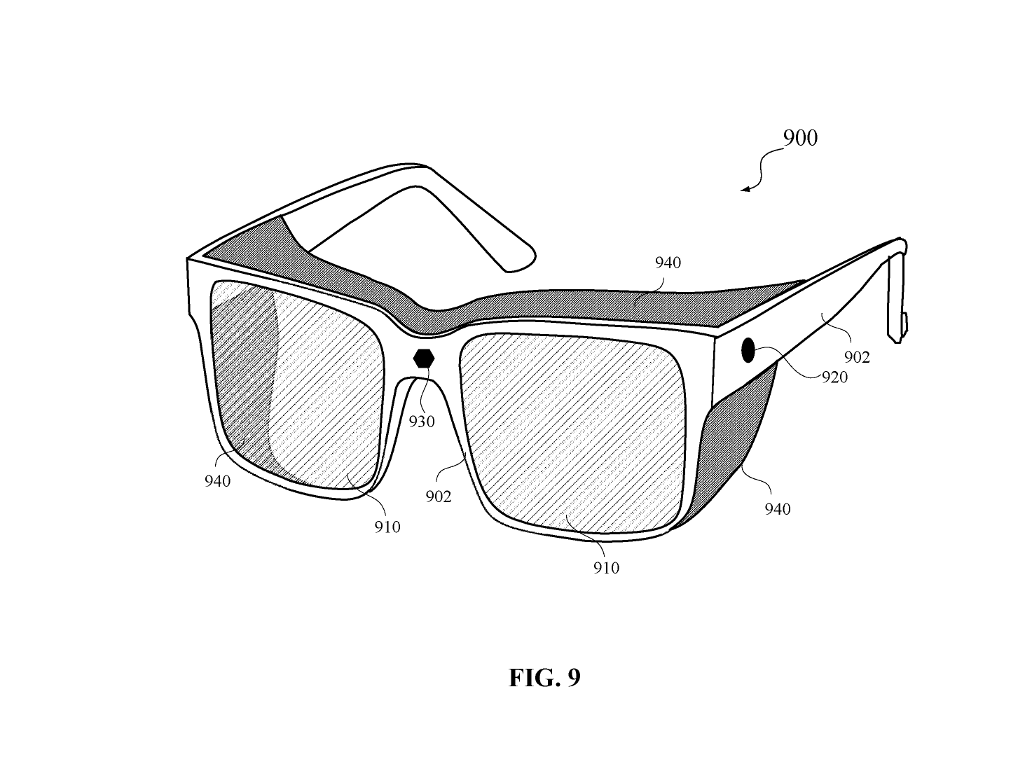

FIG. 9 illustrates an example of a head-mounted display system 900 including one or more dimmable side shields 940 according to certain embodiments. Head-mounted display system 900 may be an example of an implementation of the near-eye display or head-mounted display systems described above, and may be configured to operate as a virtual reality display, an augmented reality display, or a mixed reality display. For example, head-mounted display system 900 may be an optical see-through augmented reality or mixed reality display, or may be a video see-through augmented reality or mixed reality display. In the illustrated example, head-mounted display system 900 may include a frame 902 and two display units 910 in front of the two eyes of a user. Display units 910 may be configured to present content to a user, and may include display electronics and/or display optics. For example, as described above with respect to near-eye display 120 of FIG. 1, each display unit 910 may include an LCD display panel, an OLED display panel, an LED display panel, or an optical display panel (e.g., a waveguide display as described above with respect to FIG. 4). In some examples, the display electronics may be embedded in frame 902. In some examples where display unit 910 includes a waveguide display, a dimming element may be positioned in front of display unit 910 (e.g., between display unit 910 and the ambient environment) to at least partially attenuate ambient light. The dimming element may be an active dimming element or may be a photochromatic dimming element.

Head-mounted display system 900 may include various sensors on or within frame 902. The sensors may include, for example, one or more depth sensors, motion sensors, position sensors, inertial sensors, and the like. In one example, the sensors may include one or more ambient light sensors 920. Ambient light sensors 920 may be positioned at any locations on frame 902, and may be used to measure the ambient light intensity. In one example, ambient light sensors 920 may be positioned at the left, right, and/or front sides of frame 902 to measure the ambient light at the left, right, and/or front sides, respectively, of head-mounted display system 900. In some embodiments, the sensors may include one or more image sensors 930 (e.g., cameras) configured to generate image data representing different fields of views in different directions. For example, the cameras may capture images of the physical environment in the fields of view. The captured images may be processed, for example, by a virtual reality engine (e.g., artificial reality engine 116 of FIG. 1) to add virtual objects to the captured images or modify physical objects in the captured images, and the processed images may be displayed to the user by display units 910 for AR or MR applications. In some embodiments, the sensors may be used as input devices to control or otherwise influence the displayed content of head-mounted display system 900, and/or to provide an interactive VR/AR/MR experience to a user of head-mounted display system 900. Head-mounted display system 900 may also include other components as described above with respect to, for example, FIGS. 1-4, such as one or more illuminators to project light into the physical environment.

In some embodiments, head-mounted display system 900 may include an eye-tracking system, such as eye-tracking unit 130 described above. The eye-tracking system may include an imaging system to image one or two eyes, and may also include a light emitter (e.g., an infrared light emitter) that may generate light for illuminating the user's eye such that the light may be reflected by the user's eye and may be captured by the imaging system to determine the gazing direction of the user's eye. In some embodiments, the eye-tracking system may also detect the eye openness and the blinking of the user eyes.

Head-mounted display system 900 may include a controller or a processor that may control the operations of head-mounted display system 900, including the temporal dimming of display units 910 as described above. For example, the controller may determine a temporal luminance change curve for a dimming process, such as the temporal luminance change curves described in FIGS. 8A and 8B. The temporal luminance change curve may specify the luminance level and the corresponding duration for each luminance level of a plurality of luminance levels between a starting luminance level and a target (or end) luminance level. In some examples, the difference between two adjacent luminance levels may be less that a JND, and the duration for a luminance level may be determined based on the adaptation time at the luminance level. The controller may control display units 910 to gradually dim display units 910 using the temporal luminance change curve, such that the luminance level of display units 910 may be changed (e.g., reduced or increased) within a time period specified by the temporal luminance change curve, but the user perceived brightness may not change noticeably due to the brightness adaptation of the user's eyes during the temporal dimming. The luminance of display units 910 can be reduced by, for example, using a lower drive current for a light source (e.g., a backlight unit for an LCD display) or using lower drive currents for the light emitting pixels (e.g., OLEDs, micro-OLEDs, or micro-LEDs).

As shown in FIG. 9, head-mounted display system 900 may include one or more side shields 940 at the peripheries of head-mounted display system 900. For example, side shields 940 may be at the left side, right side, and/or top side of head-mounted display system 900, and may be shaped such that they may contact the user's face to fill gaps between the user's face and the frame of head-mounted display system 900, thereby preventing ambient light from leaking to user's eyes without being attenuated. Side shields 940 may be at least partially transparent such that the user may see through side shields 940 to view objects, such as other people, in the ambient environment. Side shields 940 may be dimmable, where the transmissivity of side shields 940 may be controlled by electrical signals. For example, side shields 940 may include active dimming elements that may be controlled to dim synchronously with display units 910. The active dimming elements may include, for example, electrochromic films, polymer-dispersed liquid crystal (PDLC) films, or other light dimming films that can change their transmissivity when the electrical signals applied to the films change. The controller for controlling the temporal dimming of display units 910 may also be used to control the dimming of the active dimming elements in the dimmable, see-through side shields, or may be synchronized with the controller for controlling the dimming of the active dimming elements in the side shields. As display units 910 are controlled to adjust their brightness over time (at a rate that may not be noticeable to the user) according to appropriate temporal luminance change curves, the active dimming elements of side shields 940 would also be controlled to adjust its transmissivity in a similar manner such that the dimming may not be noticed by the user's eyes.

In some examples, head-mounted display system 900 may use the ambient light sensor to determine the ambient luminance level and/or the spectrum of the ambient light, and may dim the active dimming elements of side shields 940 based on appropriate temporal transmissivity change curves. In one example, the temporal transmissivity change curve for dimming the side shields may have the same number of steps as the temporal luminance change curve for dimming display units 910, where each dimming step for dimming the side shields may be performed at the same time as each corresponding dimming step for dimming display units 910. In some examples, the active dimming elements of side shields 940 may be dimmed at a similar rate as display units 910. For example, if the ratio between the luminance change and the starting luminance level for display units 910 is K in one dimming step, the ratio between the transmissivity change and the starting transmissivity level for side shields 940 may also be K in the corresponding dimming step. In some examples, the luminance levels of the ambient environment and display units 910 may be determined, and a temporal luminance/transmissivity change curve may be determined based on the luminance levels of the ambient environment and/or display units 910, and may be used for dimming both side shields 940 and display units 910.

In some examples, the dimming of side shields 940 may be determined based on the luminance level of the ambient environment. For example, when the user moves from a darker environment to a brighter environment, side shields 940 may be dimmed more to further attenuate the ambient light from the bright environment, such that the brightness within head-mounted display system 900 may not increase, and thus the brightness of display units 910 would not need to be increased to match the brighter environment in order to maintain a perceptually stable user experience. When the user moves from a brighter environment to a darker environment, the dimming of side shields 940 may be unchanged (or reduced), such that the brightness within head-mounted display system 900 may be decreased (or may remain unchanged), and thus the brightness of display units 910 can be decreased to reduce power consumption (or may not be changed to maintain a perceptually stable user experience).

In some examples, the brightness and/or spectrum of light within head-mounted display system 900 (e.g., including display light and ambient light entering the region between display units 910 and the user’s eyes) may be determined using various methods, such as pixel values (e.g., RGB values), device control voltage, and/or device drive current. The dimming of side shields 940 may be determined based on the brightness/spectrum of the ambient environment (e.g., measured using the ambient light sensors), and/or the brightness/spectrum within head-mounted display system 900. For example, side shields 940 may be dimmed based on a change in the brightness of the ambient light or the light within head-mounted display system 900. In some examples, side shields 940 may be dimmed based additionally on the difference between the spectrum of the ambient light and the spectrum of the light within head-mounted display system 900. For example, ambient light of certain colors or wavelengths may be attenuated more by side shields 940 to control the spectrum of the light within head-mounted display system 900, such that the spectrum of the ambient light passing through side shields 940 and perceived by the user’s eyes may have minimum or no change even if the spectrum of the ambient light changes, and thus the display light and the ambient light passing through side shields 940 may have the same or similar color temperatures, thereby maintaining a stable perception of color.

As described above, head-mounted display system 900 may include an eye-tracking system that may determine the eye openness and detect the blinking of the user's eyes. Eye blinks involve rapid and transient closure of the eyelids, and may include: reflexive blinks, which may occur unconsciously in response to an outside stimulus; voluntary blinks, which may occur consciously; and spontaneous blinks, the most common type of blink, which may occur unconsciously at roughly 15 times per minute and are not typically evoked in response to stimuli. Each blink may have two phases: the “down phase” in which the upper eyelid rapidly descends, and the “up phase” in which the levator palpebrae (LP) superioris muscle contracts and retracts the eyelids. The down phase may be roughly twice as fast as the up phase, and may last about 75-100 milliseconds. The type of eye blink may affect the eye blink velocity and timing.

Blinks may lead to a physical occlusion of the pupil by the eyelid, a decrease in visual sensitivity independent of eyelid occlusion, and stereotyped eye movements. The full process of a blink may last about 250-450 milliseconds, and the “blackout” caused by eyelid obstruction may last about 40-200 milliseconds. During the blackout time period, the light entering the eye may be reduced to less than about 1% of the amount of light entering the eye when the eye is open. Therefore, a blink may reduce the full-field luminance and may disable the eye's ability to see for about 100 milliseconds. Pupil occlusion may also help to refresh the visual scene, in a manner similar to fixational eye movements.

In addition, blinks appear to evoke a perceptual continuity process that allows the brief visual occlusion to go unnoticed. One potential reason for the visual occlusion to go unnoticed is because blinks can decrease the visual sensitivity. It has been found that the eye's ability to detect a change in luminance may decrease up to about five-fold during a blink. The visual sensitivity to the change in luminance may start to decrease about 100 milliseconds prior to a voluntary blink, and may not return to the baseline levels until approximately 200 milliseconds after the onset of the blink. The change in visual sensitivity may be caused by an active neural suppression of visual input during a blink (“blink suppression”). It has been found that blinks can cause robust decrease in visual sensitivity across a range of stimuli and blink types.

According to certain embodiments, the decrease in visual sensitivity of the user's eye during a blink may be utilized to accelerate the dimming process without causing noticeable change in the perceived brightness during the temporal dimming. For example, the eye-tracking system of head-mounted display system 900 may detect the onset (start), full occlusion, and offset (end) of an eye blink, and the display controller of head-mounted display system 900 may, based on the detected onset, full occlusion, and offset of each blink, change the luminance levels of display units 910 and side shields 940 at larger steps or faster rates during the eye blinking without being noticed, because the user's eye may be less sensitive to luminance change during the blink.

Even though some examples disclosed herein describe the processes of decreasing the luminance level of display units 910 and side shields 940 to reduce power consumption, the luminance levels of display units 910 and the transmissivity of side shields 940 may also be increased in a similar manner (e.g., using temporal luminance change curves for increasing the luminance level as shown in FIG. 8A) without causing noticeable change in the perceived brightness, in situations where increasing the luminance level may be desired (e.g., when the luminance level of the ambient environment increases).

The addition and the coupling of the active dimming side shields to the temporal dimming display can mitigate the challenges of reducing display power consumption by temporal dimming in HMDs having open peripheries, such that the display systems of the HMDs can be temporally dimmed to reduce the display brightness and thus the power consumption, size, and/or weight of the HMD, without reducing the immersive user experience and the quality of the displayed images. The dimming of the display system enabled by the techniques disclosed herein may also improve the lifetime of the display system (e.g., reducing pixel burnout). Active dimming of the side shields may also be used as a signal to surrounding people in the ambient environment that the user of the HMD may be in "focus" mode or "do-not-disturb" mode. In addition, enclosing the display system with the side shields may help improve the visual comfort by reducing airflow through the eyebox that may otherwise increase symptoms such as dry eyes in open-periphery HMDs.

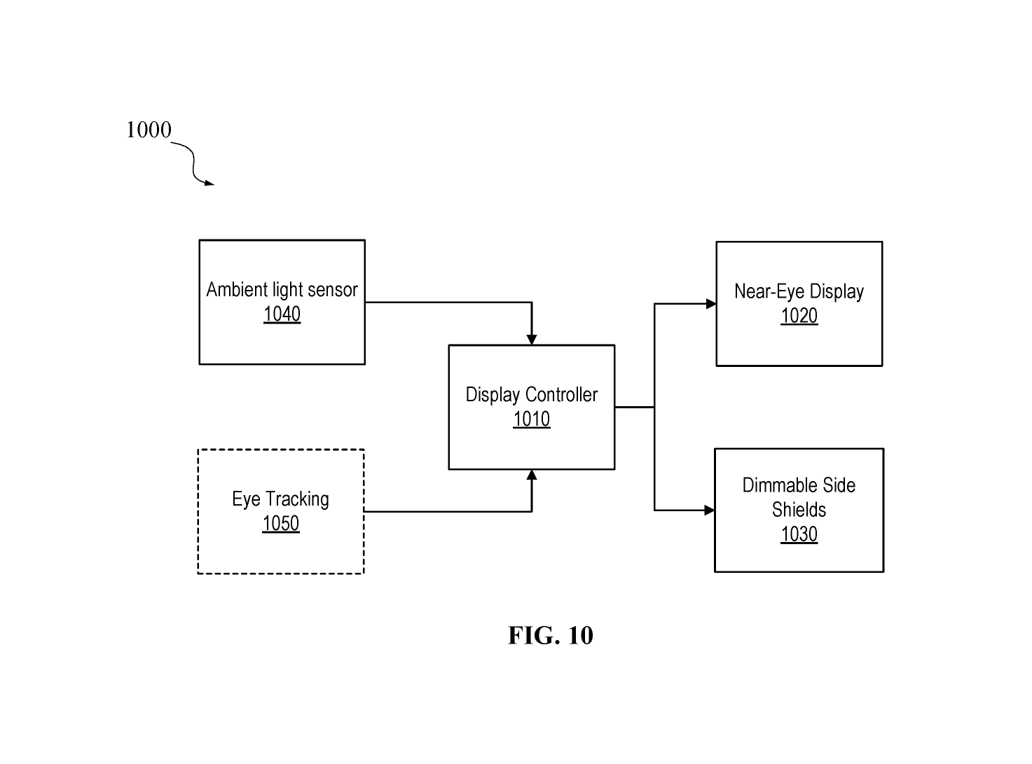

FIG. 10 illustrates an example of a subsystem 1000 for temporal dimming in a head-mounted display system according to certain embodiments. In the illustrated example, subsystem 1000 for temporal dimming may include a display controller 1010, a near-eye display 1020, one or more dimmable side shields 1030, and one or more ambient light sensors 1040. In some examples, subsystem 1000 may include an optional eye tracking or monitoring unit 1050. Near-eye display 1020 may be a virtual reality display, a video see-through augmented or mixed reality display, or an optical see-through augmented or mixed reality display. Near-eye display 1020 may include a frame and one or two display units, such as LCD panels, OLED display panels, micro-LED display panels, waveguide displays, and the like, as described above. The luminance level of near-eye display 1020 may be controlled by, for example, the driving currents of the light sources of the backlight units of the LCD panels, the driving currents of OLEDs in OLED display panels, or the driving currents of micro-LEDs in micro-LED display panels.

Side shields 1030 may be at peripheries of near-eye display 1020, such as the left side, right side, and top side of near-eye display 1020. Side shields 1030 may be shaped such that they may contact the user's face when the head-mounted display is worn by the user, and thus may prevent ambient light from leaking to the user's eyes through any gaps between the peripheries of near-eye display 1020 and user's face without being attenuated. Side shields 1030 may include a transparent substrate and may also include active dimming elements formed on or in the transparent substrate. The active dimming elements may include, for example, an electrochromic film or substrate, a polymer-dispersed liquid crystal (PDLC) film, or another film or material layer that may be controlled by electrical signals to change the transmissivity of the side shields. Side shields 1030 may be at least partially transparent such that the user may view objects in the ambient environment through side shields 1030.

Ambient light sensors 1040 may be located at the left, right, and/or front of the frame of the near-eye display, and may measure the ambient luminance level and/or light spectrum to the left, right, and/or front of the near-eye display. Optional eye tracking or monitoring unit 1050 may include an image sensor (e.g., a camera) that may capture images of the user's eyes, a processor that may process the captured images and detect the blinks of the user's eyes, and an optional light source for illuminating the user's eyes. For example, eye tracking or monitoring unit 1050 may detect the onset of an eye blink, the full occlusion of the user's eye, and the opening of the user's eye. In some example, display controller 1010 may determine the brightness and/or light spectrum within the head-mounted display system (e.g., in a region between near-eye display 1020 and the user’s eyes) may be determined using various methods, such as the pixel values (e.g., RGB values), device control voltage, and/or device drive current.

Display controller 1010 may gradually dim the near-eye display without causing a noticeable change of the perceived brightness by the user's eye, and may also gradually dim the one or more side shields based on the measured ambient luminance level/light spectrum and/or the determined brightness/light spectrum within the head-mounted display system. For example, the display controller may receive the measured ambient luminance levels and determine appropriate temporal luminance/transmissivity change curves for dimming near-eye display 1020 and side shields 1030. The display control may gradually dim near-eye display 1020 based on a temporal luminance change curve that specifies a luminance level of the near-eye display as a function of time. The temporal luminance change curve may specify a process of decreasing or increasing the luminance level of the near-eye display as a function of time. The temporal luminance change curve may specify a plurality of luminance levels for the near-eye display and the corresponding duration of each luminance level of the plurality of luminance levels for the user's eye to adapt to the luminance level. The display controller may also gradually dim the side shields based on the measure ambient luminance level and a temporal transmissivity change curve that specifies the transmissivity of the side shields as a function of time.

In some examples, the near-eye display and the side shields may be dimmed synchronously in the same number of dimming steps. For example, the display controller may be configured to dim the near-eye display and the one or more side shields at a same rate in each dimming step. In one example, if the ratio between the luminance change and the starting luminance level for the near-eye display is K in one dimming step, the ratio between the transmissivity change and the starting transmissivity level for the side shields may also be K in the corresponding dimming step. In some examples, the one or more side shields may have the same transmissivity at the same time. In some examples, the one or more side shields may have different transmissivities at the same time, where the transmissivity of each side shield of the one or more side shields may be determined based on, for example, the ambient luminance level measured by a corresponding ambient light sensor of the one or more ambient light sensors. In some examples, the luminance levels of the ambient environment and the luminance levels of the near-eye display may be determined, and the same temporal luminance/transmissivity change curves may be used for dimming both the side shields and the near-eye display.

As described above, in some examples, the dimming of dimmable side shields 1030 may be determined based on the luminance level (e.g., brightness) of the ambient environment. For example, when the user moves from a darker environment to a brighter environment, dimmable side shields 1030 may be dimmed more to further attenuate the ambient light from the bright environment, such that the brightness within the head-mounted display system may not increase, and thus the brightness of near-eye display 1020 would not need to be increased to match the brighter environment and maintain a perceptually stable user experience. When the user moves from a brighter environment to a darker environment, the dimming of dimmable side shields 1030 may be unchanged or may be reduced, such that the brightness within the head-mounted display system may be decreased or may remain unchanged, and thus the brightness of near-eye display 1020 can be decreased to reduce power consumption or may not be changed to maintain a perceptually stable user experience.

In some examples, the dimming of dimmable side shields 1030 may be determined based on the brightness/spectrum of the ambient light (e.g., measured using the ambient light sensors), and/or the brightness/spectrum of the light within the head-mounted display system (e.g., including the display light and ambient light entering the head-mounted display system). For example, dimmable side shields 1030 may be dimmed based on a change in the brightness of the ambient light or the light within the head-mounted display system. In some examples, dimmable side shields 1030 may be dimmed based additionally on the difference between the spectrum of the ambient light and the spectrum of the light within the head-mounted display system (e.g., the display light and ambient light passing through dimmable side shields 1030). For example, ambient light of certain colors or wavelengths may be attenuated more than other colors by dimmable side shields 1030 to control the spectrum of the ambient light entering the head-mounted display system, such that the spectrum of the light within the head-mounted display system may have a minimum or no change even if the spectrum of the ambient light changes, thereby controlling the white point (e.g., color temperature) of the light within the head-mounted display system and maintaining a more stable perception of color.

In some examples, the display controller may receive the eye blinking information from eye tracking or monitoring unit 1050, and dim near-eye display 1020 and the one or more side shields 1030 at higher rates during the eye blinks to accelerate the dimming, without being noticed by the user.

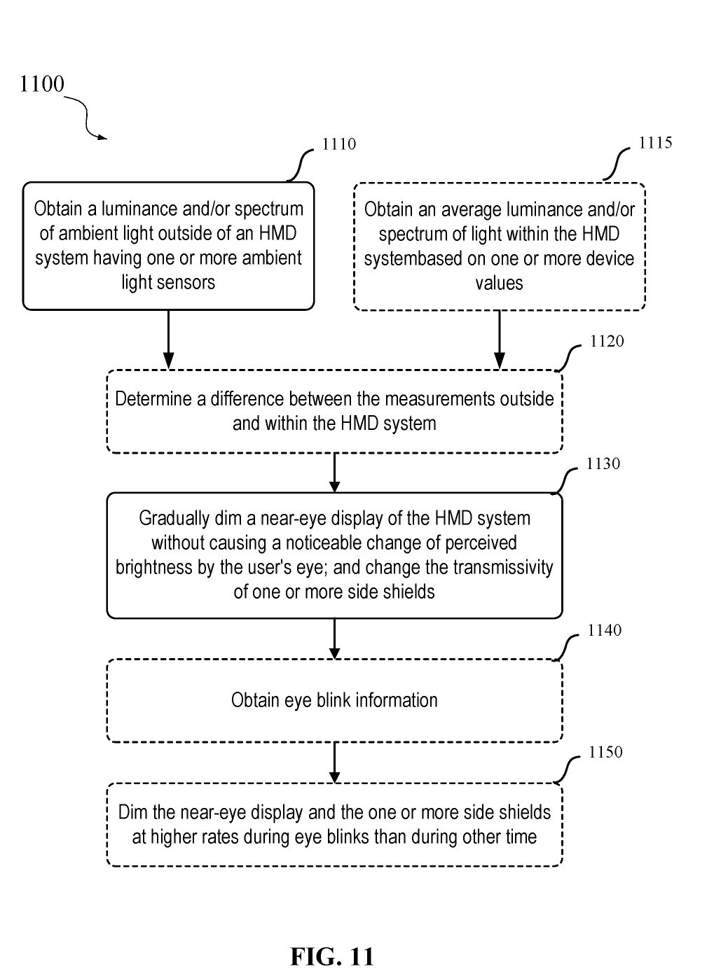

FIG. 11 includes a flowchart 1100 illustrating an example of a method of temporal dimming of a head-mounted display system according to certain embodiments. It is noted that the operations illustrated in FIG. 11 provide particular processes for temporal dimming according to certain examples. Other sequences of operations can also be performed according to alternative examples. For example, alternative examples may perform the operations in a different order. Moreover, the individual operations illustrated in FIG. 11 can include multiple sub-operations that can be performed in various sequences as appropriate for the individual operation. Furthermore, some operations can be added or removed depending on the particular example. In some examples, two or more operations may be performed in parallel. In some examples, two or more operations in flowchart 1100 may be performed iteratively. One of ordinary skill in the art would recognize many variations, modifications, and alternatives.

Operations in block 1110 may include obtaining luminance and/or spectrum of ambient light outside of a head-mounted display (HMD) system using one or more ambient light sensors of the HMD system. The luminance and/or spectrum of the ambient light may be used to control the dimming (e.g., changing the transmissivity) of the side shields of the HMD system.

Optional operations in block 1115 may include obtaining the (average) luminance and/or spectrum of light within the HMD system (e.g., including display light and ambient light entering the region between a near-eye display and the user’s eyes) using various techniques. For example, the luminance and/or spectrum of light within the HMD system may be determined based on one or more values of the HMD system, such as pixel values (e.g., RGB values of the pixels), device control voltage (e.g., control voltage of each light source or pixel), and/or device drive current (e.g., drive current of each light source or pixel). The luminance and/or spectrum of the light within the HMD system may be used to control the dimming (e.g., changing the transmissivity of) the side shields of the HMD system.

In block 1120, the luminance and/or spectrum of the ambient light outside of the HMD system and the luminance and/or spectrum of the light within the HMD system may optionally be compared to determine the difference between the luminance of the ambient light and the light within the HMD system, and the difference between the spectrum of the ambient light and the spectrum of the light within the HMD system. In some examples, the change of the luminance and/or spectrum of the ambient light over time may be determined. In some examples, the change of the luminance and/or spectrum of the light within the HMD system over time may be determined.

Operations in block 1130 may include gradually dimming the near-eye display of the HMD system without causing a noticeable change of perceived brightness by a user's eye. The near-eye display may include a frame and one or more display units in front of the user's eyes. Gradually dimming the near-eye display of the HMD system may include gradually dimming the near-eye display based on a temporal luminance change curve that specifies a luminance level of the near-eye display as a function of time. The temporal luminance change curve may specify a process of decreasing or increasing the luminance level of the near-eye display as a function of time. The temporal luminance change curve may specify a plurality of luminance levels of the near-eye display and, for each luminance level of the plurality of luminance levels, the corresponding duration for the user's eye to adapt to the luminance level. In some examples, gradually dimming the near-eye display of the HMD system may include changing luminance levels of the near-eye display in smaller steps at lower luminance levels and larger steps at higher luminance levels. In some examples, the difference between two adjacent luminance levels in the temporal luminance change curve may be less than a JND.

Operations in block 1130 may also include, while gradually dimming the near-eye display, gradually changing the transmissivity of one or more side shields that are dimmable and are configured to fill gaps between the peripheries of the near-eye display and the user's face. Gradually changing the transmissivity of the one or more side shields may include gradually dimming the side shields based on the ambient luminance level and a temporal transmissivity change curve that specifies the transmissivity of the side shields as a function of time. In some examples, the near-eye display and the one or more side shields may be dimmed at a same rate in each dimming step as described above.

In some examples, the one or more side shields may be dimmed based on the difference between the spectrum of the ambient light and the spectrum of the light within the HMD system. For example, ambient light of certain colors or wavelengths may be attenuated more than other colors by the one or more side shields to control the spectrum of the light within the HMD system, such that the spectrum of the light within the head-mounted display system may have minimum or no change even if the spectrum of the ambient light changes, thereby controlling the white point (e.g., color temperature) of the light within the head-mounted display system and maintaining a stable perception of color.

In some examples, the one or more side shields may be dimmed more quickly based on a change of the luminance of the ambient light or the light within the HMD system. For example, when the user moves from a darker environment to a brighter environment, the one or more side shields may be dimmed more quickly to attenuate the ambient light from the bright environment, such that the brightness within the head-mounted display system may not increase, and thus the brightness of the near-eye display would not need to be increased in order to maintain a perceptually stable user experience. When the user moves from a brighter environment to a darker environment, the dimming of the one or more side shields may be unchanged and the brightness within the head-mounted display system may be decreased, and thus the brightness of the near-eye display can be decreased to reduce power consumption while maintain a perceptually stable user experience.

Optional operations in block 1140 may include obtaining eye blink information, for example, from an eye tracking or monitoring system. Optional operations in block 1150 may include dimming the near-eye display and the one or more side shields at higher rates during eye blinks than during other time, thereby accelerating the temporal dimming without being noticed, because the user's eye may have a lower sensitivity during eye blinks.

Embodiments disclosed herein may be used to implement components of an artificial reality system or may be implemented in conjunction with an artificial reality system. Artificial reality is a form of reality that has been adjusted in some manner before presentation to a user, which may include, for example, a virtual reality, an augmented reality, a mixed reality, a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., perform activities in) an artificial reality. The artificial reality system that provides the artificial reality content may be implemented on various platforms, including an HMD connected to a host computer system, a standalone HMD, a mobile device or computing system, or any other hardware platform capable of providing artificial reality content to one or more viewers.

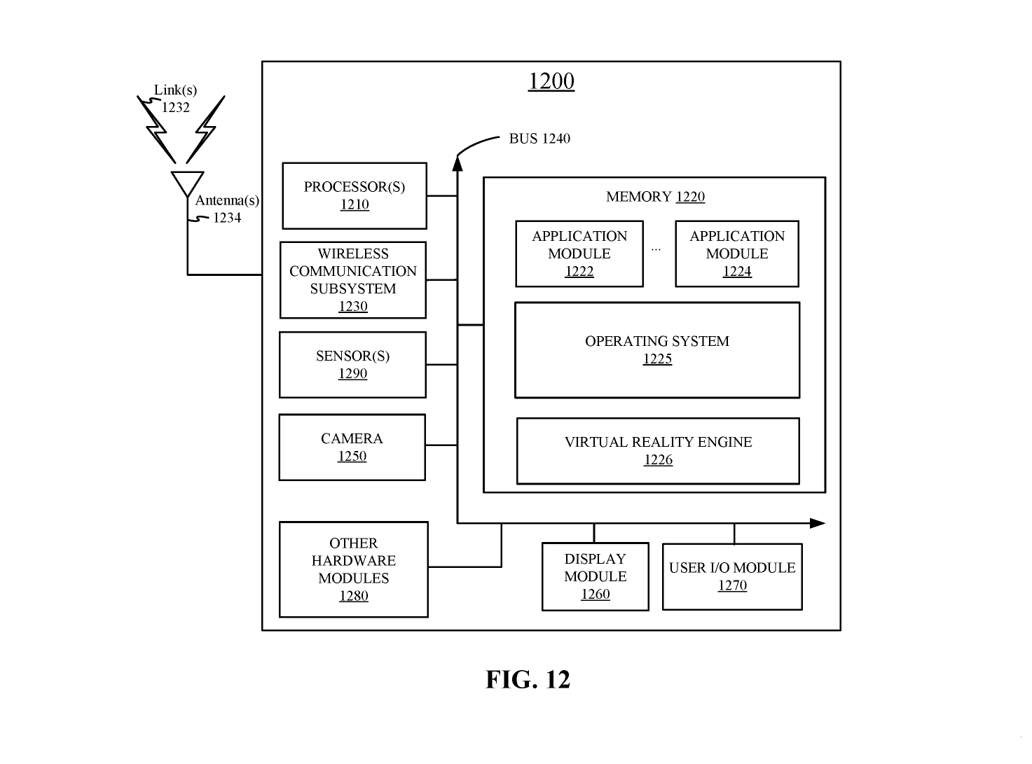

FIG. 12 is a simplified block diagram of an example electronic system 1200 of an example near-eye display (e.g., HMD device) for implementing some of the examples disclosed herein. Electronic system 1200 may be used as the electronic system of an HMD device or other near-eye displays described above. In this example, electronic system 1200 may include one or more processor(s) 1210 and a memory 1220. Processor(s) 1210 may be configured to execute instructions for performing operations at a number of components, and can be, for example, a general-purpose processor or microprocessor suitable for implementation within a portable electronic device. Processor(s) 1210 may be communicatively coupled with a plurality of components within electronic system 1200. To realize this communicative coupling, processor(s) 1210 may communicate with the other illustrated components across a bus 1240. Bus 1240 may be any subsystem adapted to transfer data within electronic system 1200. Bus 1240 may include a plurality of computer buses and additional circuitry to transfer data.

Memory 1220 may be coupled to processor(s) 1210. In some embodiments, memory 1220 may offer both short-term and long-term storage and may be divided into several units. Memory 1220 may be volatile, such as static random access memory (SRAM) and/or dynamic random access memory (DRAM) and/or non-volatile, such as read-only memory (ROM), flash memory, and the like. Furthermore, memory 1220 may include removable storage devices, such as secure digital (SD) cards. Memory 1220 may provide storage of computer-readable instructions, data structures, program modules, and other data for electronic system 1200.

In some embodiments, memory 1220 may store a plurality of application modules 1222 through 1224, which may include any number of applications. Examples of applications may include gaming applications, conferencing applications, video playback applications, or other suitable applications. The applications may include a depth sensing function or eye tracking function. Application modules 1222-1224 may include particular instructions to be executed by processor(s) 1210. In some embodiments, certain applications or parts of application modules 1222-1224 may be executable by other hardware modules 1280. In certain embodiments, memory 1220 may additionally include secure memory, which may include additional security controls to prevent copying or other unauthorized access to secure information.

In some embodiments, memory 1220 may include an operating system 1225 loaded therein. Operating system 1225 may be operable to initiate the execution of the instructions provided by application modules 1222-1224 and/or manage other hardware modules 1280 as well as interfaces with a wireless communication subsystem 1230 which may include one or more wireless transceivers. Operating system 1225 may be adapted to perform other operations across the components of electronic system 1200 including threading, resource management, data storage control and other similar functionality.

Wireless communication subsystem 1230 may include, for example, an infrared communication device, a wireless communication device and/or chipset (such as a Bluetooth® device, an IEEE 802.11 device, a Wi-Fi device, a WiMax device, cellular communication facilities, etc.), and/or similar communication interfaces. Electronic system 1200 may include one or more antennas 1234 for wireless communication as part of wireless communication subsystem 1230 or as a separate component coupled to any portion of the system. Depending on desired functionality, wireless communication subsystem 1230 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15x, or some other types of network. The techniques described herein may also be used for any combination of WWAN, WLAN, and/or WPAN. Wireless communications subsystem 1230 may permit data to be exchanged with a network, other computer systems, and/or any other devices described herein. Wireless communication subsystem 1230 may include a means for transmitting or receiving data, such as identifiers of HMD devices, position data, a geographic map, a heat map, photos, or videos, using antenna(s) 1234 and wireless link(s) 1232.

Embodiments of electronic system 1200 may also include one or more sensors 1290. Sensor(s) 1290 may include, for example, an image sensor, an accelerometer, a pressure sensor, a temperature sensor, a proximity sensor, a magnetometer, a gyroscope, an inertial sensor (e.g., a module that combines an accelerometer and a gyroscope), an ambient light sensor, or any other similar module operable to provide sensory output and/or receive sensory input, such as a depth sensor or a position sensor.

Electronic system 1200 may include a display module 1260. Display module 1260 may be a near-eye display, and may graphically present information, such as images, videos, and various instructions, from electronic system 1200 to a user. Such information may be derived from one or more application modules 1222-1224, virtual reality engine 1226, one or more other hardware modules 1280, a combination thereof, or any other suitable means for resolving graphical content for the user (e.g., by operating system 1225). Display module 1260 may use LCD technology, LED technology (including, for example, OLED, ILED, μ-LED, AMOLED, TOLED, etc.), light emitting polymer display (LPD) technology, or some other display technology.

Electronic system 1200 may include a user input/output module 1270. User input/output module 1270 may allow a user to send action requests to electronic system 1200. An action request may be a request to perform a particular action. For example, an action request may be to start or end an application or to perform a particular action within the application. User input/output module 1270 may include one or more input devices. Example input devices may include a touchscreen, a touch pad, microphone(s), button(s), dial(s), switch(es), a keyboard, a mouse, a game controller, or any other suitable device for receiving action requests and communicating the received action requests to electronic system 1200. In some embodiments, user input/output module 1270 may provide haptic feedback to the user in accordance with instructions received from electronic system 1200. For example, the haptic feedback may be provided when an action request is received or has been performed.

Electronic system 1200 may include a camera 1250 that may be used to take photos or videos of a user, for example, for tracking the user’s eye position. Camera 1250 may also be used to take photos or videos of the environment, for example, for VR, AR, or MR applications. Camera 1250 may include, for example, a complementary metal–oxide–semiconductor (CMOS) image sensor with a few millions or tens of millions of pixels. In some implementations, camera 1250 may include two or more cameras that may be used to capture 3-D images.

In some embodiments, electronic system 1200 may include a plurality of other hardware modules 1280. Each of other hardware modules 1280 may be a physical module within electronic system 1200. While each of other hardware modules 1280 may be permanently configured as a structure, some of other hardware modules 1280 may be temporarily configured to perform specific functions or temporarily activated. Examples of other hardware modules 1280 may include, for example, an audio output and/or input module (e.g., a microphone or speaker), a near field communication (NFC) module, a rechargeable battery, a battery management system, a wired/wireless battery charging system, etc. In some embodiments, one or more functions of other hardware modules 1280 may be implemented in software.

In some embodiments, memory 1220 of electronic system 1200 may also store a virtual reality engine 1226. Virtual reality engine 1226 may execute applications within electronic system 1200 and receive position information, acceleration information, velocity information, predicted future positions, or any combination thereof of the HMD device from the various sensors. In some embodiments, the information received by virtual reality engine 1226 may be used for producing a signal (e.g., display instructions) to display module 1260. For example, if the received information indicates that the user has looked to the left, virtual reality engine 1226 may generate content for the HMD device that mirrors the user’s movement in a virtual environment. Additionally, virtual reality engine 1226 may perform an action within an application in response to an action request received from user input/output module 1270 and provide feedback to the user. The provided feedback may be visual, audible, or haptic feedback. In some implementations, processor(s) 1210 may include one or more GPUs that may execute virtual reality engine 1226.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or any combination of A, B, and/or C, such as AB, AC, BC, AA, ABC, AAB, AABBCCC, etc.

In this description, the recitation “based on” means “based at least in part on.” Therefore, if X is based on Y, then X may be a function of at least a part of Y and any number of other factors. If an action X is "based on" Y, then the action X may be based at least in part on at least a part of Y.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A head-mounted display system comprising:
a near-eye display configured to present images to a user's eye;
one or more side shields configured to fill gaps between the user's face and peripheries of the near-eye display, wherein the one or more side shields are at least partially transparent to visible light and are dimmable using an electrical control signal; and
a controller configured to control dimming of the near-eye display and the one or more side shields.

2. The head-mounted display system of claim 1, wherein the controller is configured to:
gradually dim the near-eye display without causing a noticeable change of perceived brightness by the user's eye; and
gradually dim the one or more side shields while gradually dimming the near-eye display.

3. The head-mounted display system of claim 2, wherein the controller is configured to gradually dim the near-eye display based on a temporal luminance change curve that specifies a luminance level of the near-eye display as a function of time.

4. The head-mounted display system of claim 3, wherein the temporal luminance change curve specifies a process of decreasing or increasing the luminance level of the near-eye display as a function of time.

5. The head-mounted display system of claim 3, wherein the temporal luminance change curve specifies a plurality of luminance levels of the near-eye display and a corresponding duration of each luminance level of the plurality of luminance levels for the user's eye to adapt to the luminance level.

6. The head-mounted display system of claim 2, wherein the controller is configured to dim the near-eye display and the one or more side shields at a same rate in each dimming step of a plurality of dimming steps.

7. The head-mounted display system of claim 2, further comprising an eye tracking subsystem configured to detect eye blinks, wherein the controller is configured to dim the near-eye display and the one or more side shields at a higher rate during the eye blinks than during other time.

8. The head-mounted display system of claim 1, further comprising:
at least one ambient light sensor configured to measure a luminance and/or a spectrum of ambient light of the head-mounted display system,
wherein the controller is configured to control the dimming of the one or more side shields based at least in part on the luminance and/or the spectrum of the ambient light of the head-mounted display system.

9. The head-mounted display system of claim 8, wherein the controller is configured to gradually dim the one or more side shields based on the luminance of the ambient light and a temporal transmissivity change curve that specifies a transmissivity of the one or more side shields as a function of time.

10. The head-mounted display system of claim 8, wherein the controller is configured to reduce transmissivity of the one or more side shields in response to an increase of the luminance of the ambient light of the head-mounted display system.

11. The head-mounted display system of claim 8, wherein the controller is configured to:
determine a spectrum of light within the head-mounted display system;
determine a difference between the spectrum of the ambient light and the spectrum of the light within the head-mounted display system; and
dim the one or more side shields based on the difference such that a color temperature of the ambient light dimmed by the one or more side shields matches a color temperature of the light within the head-mounted display system.

12. The head-mounted display system of claim 11, wherein the controller is configured to determine the spectrum of the light within the head-mounted display system based on one or more values of the near-eye display.

13. The head-mounted display system of claim 12, wherein the one or more values of the near-eye display include pixel color values, pixel control voltage values, pixel drive current values, light source control voltage values, light source drive current values, or a combination thereof.

14. The head-mounted display system of claim 1, wherein each of the one or more side shields comprises an active dimming element formed in or on a substrate.

15. The head-mounted display system of claim 14, wherein the active dimming element includes an electrochromic material or a polymer-dispersed liquid crystal (PDLC) film.

16. The head-mounted display system of claim 1, wherein the near-eye display includes a virtual reality display, an optical see-through augmented reality display, or a video see-through augmented reality display.

17. A processor-implemented method comprising:
obtaining a luminance and/or a spectrum of ambient light of a head-mounted display (HMD) system using one or more ambient light sensors;
gradually dimming a near-eye display of the HMD system without causing a noticeable change of perceived brightness by a user's eye; and
based at least in part on the luminance and/or the spectrum of the ambient light of the HMD system, changing a transmissivity of one or more side shields that are dimmable and are configured to fill gaps between the user's face and peripheries of the near-eye display.

18. The processor-implemented method of claim 17, wherein gradually dimming the near-eye display of the HMD system comprises gradually dimming the near-eye display based on a temporal luminance change curve that specifies a luminance level of the near-eye display as a function of time for the user's eye to adapt to the luminance level.

19. The processor-implemented method of claim 17, wherein changing the transmissivity of the one or more side shields comprises:
gradually changing the transmissivity of the one or more side shields based on the luminance of the ambient light and a temporal transmissivity change curve that specifies the transmissivity of the one or more side shields as a function of time;
gradually dimming the near-eye display and the one or more side shields at a same rate in each dimming step of a plurality of dimming steps;
reducing the transmissivity of the one or more side shields in response to an increase of the luminance of the ambient light of the head-mounted display system;
changing a spectral transmissivity of the one or more side shields such that a color temperature of the ambient light dimmed by the one or more side shields matches a color temperature of display light of the near-eye display; or
a combination thereof.

20. The processor-implemented method of claim 17, further comprising:
obtaining eye blink information; and
dimming the near-eye display and the one or more side shields at a higher rate during eye blinks than during other time.
